(19) United States
(12) Patent Application Publication
(10) Pub. No.: US 2019/0356014 A1
(43) Pub. Date: Nov. 21, 2019

(54) A LITHIUM ION SECONDARY BATTERY AND A METHOD FOR PRODUCING THE SAME

(71) Applicant: MAXELL HOLDINGS, LTD., Otokuni-gun, Kyoto (JP)

(72) Inventors: Hiroshi Abe, Otokuni-gun (JP); Susumu Yoshikawa, Otokuni-gun (JP); Tomohito Sekiya, Otokuni-gun (JP)

(73) Assignee: MAXELL HOLDINGS, LTD., Otokuni-gun, Kyoto (JP)

(21) Appl. No.: 16/331,276

(22) PCT Filed: Aug. 28, 2017
(86) PCT No.: PCT/JP2017/030754

§ 371 Date: Mar. 7, 2019

(30) Foreign Application Priority Data
Sep. 8, 2016 (JP) 2016-175351

(51) Int. Cl. H01M 10/0525; H01M 4/48; H01M 10/0569; H01M 4/36; H01M 4/525; H01M 2/16

(52) U.S. Cl. CPC H01M 10/0525; H01M 4/483; H01M 10/0569; H01M 4/366; H01M 2220/30; H01M 2/1686; H01M 2/1653; H01M 2300/0037; H01M 4/525

(57) ABSTRACT

The lithium ion secondary battery includes an electrode body and a nonaqueous electrolyte liquid. The negative electrode active material in the negative electrode includes a materials S including Si. Assuming that a total of all negative electrode active materials included in the negative electrode is 100 mass %, a content of the material S is higher than 5 mass %. The nonaqueous electrolyte liquid comprises propylene carbonate and a chain carbonate as a solvent. A volume content of the propylene carbonate in the solvent is 10 to 50 volume %. The positive electrode comprises a positive electrode composition layer comprising a metal oxide comprising Li and a metal M except for Li as a positive electrode active material provided on at least one surface of a positive electrode current collector. The lithium ion secondary battery has an upper limit voltage in charge is 4.35 V of more.

### TECHNICAL FIELD

The present invention relates to a lithium ion secondary battery with a high capacity and having excellent charge discharge cycle characteristics. The present invention also relates to a production method thereof.

### BACKGROUND OF THE INVENTION

The lithium ion secondary batteries, that is, a kind of electrochemical elements, are considered applicable to portable devices, automobiles, electric tools, electric chairs, and electricity storage systems both for family use and business use, since it is characterized in a high energy density. Particularly, in portable devices, it is widely used as a power source of cell phones, smartphones or tablet type PCs.

As applicable apparatus of the lithium ion secondary battery being spread, it has been demanded to increase its capacity as well as to improve its batteries' properties in various aspects. Particularly, as a secondary battery, its improvement of the charge discharge cycle characteristic is strongly demanded.

Usually, in a negative electrode active material of the lithium ion secondary battery, a carbon material such as graphite which is capable of insertion and desorption of lithium (Li) ions is widely used. On the other hand, Si or Sn or a material including such an element have been examined as a material capable of insertion and desorption of more amounts of lithium (Li) ions, and a compound SiOₓ having a structure that fine particles of Si are dispersed in SiO₂ is particularly focused on. Also, since these materials have a low conductivity, it has been proposed to make them into a structure in which the surface of the particles is coated with a conductive material such as carbon (Patent References No. 1 and No. 2).

It has been proposed to improve the charge discharge efficiency at the first time and the cycle characteristics by using polyamideimide as a binder in the materials including the Si or the Sn, or materials including these elements. (Patent References No. 3 and No. 4).

It has been proposed to improve a lithium secondary battery with a charge voltage of 4.4 V in view of the cycle characteristics and the recovery capacity after a high temperature storage by comprising a negative electrode active material including graphite and a material S including at least one element selected from the group consisting of Si and Sn, and an electrolyte liquid including ethylene carbonate and diethyl carbonate (Patent Reference No. 5).

In addition, it has been proposed to improve battery characteristics by providing a negative electrode with Si or Sn, or a material including these elements, and comprising an electrolyte liquid including at least propylene carbonate in the solvent (Patent Reference Nos. 6-11).

### PRIOR ART REFERENCES

### Patent References

Patent Reference No. 1: Japanese Laid-Open Patent Publication No. 2004-47,404
Patent Reference No. 2: Japanese Laid-Open Patent Publication No. 2005-259,697
Patent Reference No. 3: Japanese Laid-Open Patent Publication No. 2011-060676
Patent Reference No. 4: Japanese Laid-Open Patent Publication No. 2015-065163
Patent Reference No. 5: Japanese Laid-Open Patent Publication No. 2016-062760
Patent Reference No. 6: Japanese Laid-Open Patent Publication No. 2003-115,293
Patent Reference No. 7: Japanese Laid-Open Patent Publication No. 2003-249,211
Patent Reference No. 8: Japanese Laid-Open Patent Publication No. 2010-257,989
Patent Reference No. 9: Japanese Laid-Open Patent Publication No. 2011-040326
Patent Reference No. 10: Japanese Laid-Open Patent Publication No. 2013-251,204
Patent Reference No. 11: Japanese Laid-Open Patent Publication No. 2016-143642

### SUMMARY OF THE INVENTION

### The Objectives to Solve by the Invention

In case of lithium ion secondary batteries as explained above, it is often to use an electrolyte liquid solvent mainly composed of ethylene carbonate as an electrolyte liquid. However, in case of a battery which has been manufactured with use of an electrolyte liquid solvent mainly composed of ethylene carbonate and further in combination with a negative electrode material including Si, there is a report that the battery was remarkably swollen after it had still stored at a high temperature such as 60° C. for a certain period of time. In addition, there is a room to improve the cycle characteristics. Also, with the use of propylene carbonate, the upper limit of the voltage in charge is 4.3 V, but there is a room to improve it in light of high capacity.

The present invention was accomplished in view of the circumstances above, and the present invention provides a lithium ion secondary battery superior in storage properties and charge discharge cycle characteristics, as well as a production method thereof.

### Means to Solve the Problem

The present invention provides a lithium ion secondary battery, comprising: an electrode body comprising a positive electrode, a negative electrode and a separator therebetween which are stacked or wound; and a nonaqueous electrolyte liquid. The negative electrode has a negative electrode composition layer mainly composed of a negative electrode active material provided on at least one surface of a negative electrode current collector, the negative electrode active material including a materials S including Si. Assuming that a total of all negative electrode active materials included in the negative electrode is 100 mass %, a content of the material S is higher than 5 mass %, the nonaqueous electrolyte liquid comprising propylene carbonate and a chain carbonate as a solvent. A volume content of the propylene carbonate in the solvent is 10 to 50 volume %. The positive electrode comprises a positive electrode composition layer comprising a metal oxide comprising Li and a metal M except for Li as a positive electrode active material provided on at least one surface of a positive electrode current collector. The lithium ion secondary battery has an upper limit voltage in charge is 4.35 V of more.

Also, according to the first aspect of the production method of the present invention, a third electrode is further provided to insert Li ions into the negative electrode. The third electrode is disposed at least at an end face of the electrode body stacked such that the third electrode is electrically conductive with the negative electrode. Using the third electrode having a Li supply source, the third electrode is electrically connected with the negative electrode so as to insert Li ions into the negative electrode.

In addition, according to the second aspect of the production method of the present invention, there is produced an embodiment in which the negative electrode has been made of a negative electrode composition layer including a negative electrode active material not including Li, the negative electrode composition layer being doped with Li ions. In this method, a negative electrode having the negative electrode composition layer comprising a material not including Li and a binder is provided, and the negative electrode composition layer is doped with Li ions. Then, thereby obtained negative electrode is used to manufacture a lithium ion secondary battery.

### Effects of the Invention

According to the present invention, it can be possible to provide a lithium ion secondary battery superior in storage properties and cycle characteristics.

### BRIEF DESCRIPTION OF THE DRAWINGS

FIG. 1 is a plan view showing an example of the positive electrode of the present invention.

FIG. 2 is a plan view showing an example of the negative electrode of the present invention.

FIG. 3 is a perspective view schematically showing an example of the stacked electrode body.

FIG. 4 is a perspective view showing an example of the third electrode.

FIG. 5 is a perspective view showing an electrode body which is in an assembled condition of the stacked electrode body of FIG. 3 with the third electrode of FIG. 4.

FIG. 6 is an illustrative drawing of the process to dope the negative electrode composition layer of the negative electrode with Li ions through a roll-to-roll method.

FIG. 7 is a plan view showing an example of the lithium ion secondary battery of the present invention.

FIG. 8 is a cross section view at the line I-I of FIG. 7.

### EMBODIMENTS TO CARRY OUT THE INVENTION

The inventors of the present invention has found that the lithium ion secondary battery of the present invention including material S including Si as a negative electrode active material can significantly restrict the swollenness of the battery even when stored at a high temperature, if using an electrolyte liquid solvent including propylene carbonate at an amount of 10 volume % or more and 50 volume % or less in the electrolyte liquid.

The negative electrode of the lithium ion secondary battery of the present invention has a structure in which, for example, a negative electrode composition layer including a negative electrode active material and a binder is formed on one surface or both surfaces of a current collector.

The negative electrode active material of the present invention includes a negative electrode material, that is, a material S including Si. Si is known to introduce Li ions when it is alloyed with Li. It is also known that it shows a large volume expansion at the time when Li is introduced.

It is characterized in that the materials S including the Si shows a capacity of 1000 mAh/g or more, remarkably exceeding a theoretical capacity of graphite, that is to be said as 372 mAh/g. Meanwhile, comparing the charge discharge efficiency (i.e., 90% or more) of conventional graphite, there are many instances in case of the material S including Si in which the initial charge discharge efficiency does not reach 80%, and therefore, an irreversible capacity can be increased and raise an issue of the cycle characteristics. Thus, it is desirable to introduce Li ions into the negative electrode (negative electrode active material) in advance.

As a method to introduce Li ions into the negative electrode active material, there are an intrasystem pre-dope method and an outside-system pre-dope method. The examples of the intrasystem pre-dope method can include a method in which a negative electrode composition layer is provided, which is followed by disposing a Li source to face the composition layer by e.g. stitching a metal lithium foil or forming a Li vapor deposition layer thereon such that an electrochemical contact (short circuit) is made to introduce Li ions. The examples of the outside-system pre-dope method can include a method in which the negative electrode is added into a metal lithium solution (e.g., a solution which has dissolved a polycyclic aromatic compound and metal Li in a solvent such as an ether) so as to dope Li ions (i.e., a solution method); and a method in which both the negative electrode (i.e., an action pole) and a lithium metal pole (i.e., an opposite pole lithium metal foil or a lithium alloy foil can be used.) are immersed in a nonaqueous electrolyte liquid, followed by making an electric conduction therebetween so as to dope Li ions (i.e., a lithium metal electric conduction method).

However, in the intrasystem pre-dope method when Li ions are introduced as being opposed to the composition layer, it must have arranged a Li source for each negative electrode composition layer inside the stacked electrode body, and thereby being inferior in the production efficiency. In order to avoid it, as a metal foil to become a support of the composition layers of the positive electrode and the negative electrode, there has been used one which has a through hole from one surface to the other surface. In this way, it is possible to arrange a Li source only on the outermost surface of the stacked electrode body in the stacking direction, while Li ions can entirely spread in the stacked electrode body through the through hole of the metal foil, thereby allowing Li ions to be introduced into the all negative electrodes.

However, while the material S can accept a large amount of Li ions, it shows a significant expansion upon accepting the Li ions. Therefore, the negative electrode composition layer of the negative electrode closest to the Li source receives the most Li ions, thereby remarkably expanding. As a result, it might fall off by losing an adhesion condition with the negative electrode current collector.

In view of the above, disposition of a Li source at the end face of the stacked electrode body can remove a complicated work to dispose many Li sources while making a construction that the metal foil can endure remarkable expansion or shrinkage, and therefore, it is considered particularly preferable as a method to introduce Li ions into the negative electrode active material.

Also, in case of the outside-system pre-dope method, while the outside-system pre-dope of the negative electrode is made by immersing the negative electrode (i.e., an action pole) and a lithium metal pole (i.e., an opposite poles; a lithium metal foil or a lithium alloy foil can be used.) into a nonaqueous electrolyte liquid, followed by making electrical conduction therebetween. The nonaqueous electrolyte liquid in this process can be the same one as used as a nonaqueous electrolyte liquid for an electrochemical element such as a lithium ion secondary battery. The dope amount of the Li ions at this time can be controlled by adjusting a current density per an area of the negative electrode (negative electrode composition layer) or a quantity of current electricity.

It is preferable that the outside-system pre-dope of the negative electrode can be made by a roll-to-roll method as explained below. That is, a negative electrode having formed a negative electrode composition layer on the surface of a current collector is wound as a roll; a negative electrode is drawn from this roll such that the negative electrode is introduced into an electrolyte liquid bath provided with a nonaqueous electrolyte liquid and a lithium metal pole; followed by making electrical conduction between the negative electrode and the lithium metal pole, thereby doping Li ions into the negative electrode composition layer.

The material S is a negative electrode materials including Si. The examples of the material S include a complex material in which Si powders are complexed with carbon, or a material further coating it with a carbon material; a material in which Si powders are held by graphenes or scale-like graphites; and a material represented by a composition formula SiOₓ including Si and O as constituent elements (here, the atom ratio x of O to Si is 0.5≤x≤1.5). Among them, it is preferable to use SiOₓ.

The SiOₓ can include microcrystals or an amorphous phase of Si. In this case, the atomic ratio of Si and O is determined with including the microcrystals or the amorphous phase of Si. In other words, the SiOₓ can be provided in a structure in which Si (e.g., microcrystalline Si) is dispersed in an amorphous SiO₂ matrix, where the atomic ratio x can be determined by including the amorphous SiO₂ and the Si dispersed in the amorphous SiO₂, satisfying 0.5≤x≤1.5. For example, when the material is provided as having a structure in which Si is dispersed in an amorphous SiO₂ matrix, and the molar ratio of SiO₂ and Si is 1:1, the structural formula of this material can be represented by SiO because x=1 is established. In the case of the material having such a structure, a peak resulting from the presence of Si (microcrystalline Si) might not be observed, e.g., by X-ray diffraction analysis, but the presence of fine Si can be confirmed by transmission electron microscope observation.

Also, it is favorable that SiOₓ is a complex with a carbon material, and for example, it is desirable that the surface of SiOₓ is coated with a carbon material. Usually, SiOₓ has a poor conductivity. Therefore, if this is used as a negative electrode active material, in view of securing good battery properties, a conductive material (i.e., conductive assistant) is used such that the mixing and dispersing of the SiOₓ and the conductive material in the negative electrode are made better, thereby forming a superior conductive network. By using such a complex of SiOₓ and carbon material, a better conductive network can be formed in the negative electrode rather than using a material obtained by solely mixing SiOₓ with carbon material.

That is, the specific resistance value of an SiOₓ is generally 10³ to 10⁷ kΩm, whereas the specific resistance value of the carbon material as described above is generally 10⁻⁵ to 10 kΩm. However, the conductivity of the SiOₓ can be improved by complexing the SiOₓ with the carbon material.

The composite of the SiOₓ and the carbon material can be, e.g., a granular material of the SiOₓ and the carbon material, in addition to the above composite obtained by coating the surface of the SiOₓ with the carbon material.

Preferred examples of the carbon material that can be used with the SiOₓ to form the composite can include a low crystalline carbon, carbon nanotube, and a vapor grown carbon fiber.

Specifically, it is preferable that the carbon material is at least one selected from the group consisting of a fibrous or coil-shaped carbon material, carbon black (including acetylene black and KETJEN Black), artificial graphite, an easily-graphitizable carbon, and a hardly-graphitizable carbon. The fibrous or coil-shaped carbon material is preferably used because it has a large surface area and allows the conductive network to be easily formed. The carbon black (including acetylene black and KETJEN. Black), the easily-graphitizable carbon, and the hardly-graphitizable carbon are preferable because they have high electrical conductivity and high liquid-retaining property, and also are likely to remain in contact with SiOₓ particles even when the SiOₓ particles expand and contract.

Among the above carbon materials, it is particularly preferable to use the fibrous carbon material when the composite of the SiOₓ and the carbon material is a granular material. This is because the fibrous carbon material is in the form of a fine thread and highly flexible, and thus can follow the expansion and contraction of the SiOₓ during charge and discharge of the battery. Moreover, the fibrous carbon material has a high bulk density, and thus can have many contact points with the SiOₓ particles. The examples of the fibrous carbon can include a polyacrylonitrile (PAN) carbon fiber, a pitch carbon fiber, a vapor grown carbon fiber, and carbon nanotube. One of any as exemplified above can be used.

When the composite of the SiOₓ and the carbon material is used as the negative electrode, the ratio of the SiOₓ and the carbon material is determined such that the carbon material is preferably 5 parts by weight or more, and more preferably 10 parts by weight or more, with respect to 100 parts by weight of the SiOₓ, so as to obtain a sufficient effect resulting from the combination of the SiOₓ and the carbon material. On the other hand, if the ratio of the carbon material to be combined with the SiOₓ in the composite, is too large, the amount of the SiOₓ in the negative electrode mixture layer leads to a decrease, which in turn might reduce the effect of attaining a high capacity. Therefore, the carbon material is preferably 50 parts by weight or less, and more preferably 40 parts by weight or less, with respect to 100 parts by weight of the SiOₓ.

The composite of the SiOₓ and the carbon material can be obtained, e.g., in the following manner.

When the composite is formed by coating the surface of the SiOₓ with the carbon material, the SiOₓ particles and a hydrocarbon gas, for example, are heated in a gas phase, and the carbon produced by thermal decomposition of the hydrocarbon gas is deposited on the surfaces of the particles. Such a chemical vapor deposition (CVD) method allows the hydrocarbon gas to totally spread over the SiOₓ particles, so that a thin uniform film (carbon material coating layer) including the carbon material with conductivity can be formed on the surfaces of the particles. Thus, it is possible to make the SiOₓ particles uniformly conductive with a small amount of the carbon material.

In the production of the SiOₓ coated with the carbon material, the treatment temperature (ambient temperature) of the CVD method varies depending on the type of the hydrocarbon gas, but it is generally 600 to 1200° C. In particular, the treatment temperature is preferably 700° C. or higher, and more preferably 800° C. or higher. This is because the residual impurities can be reduced at setting it up at a higher treatment temperature as possible, and as a result, a coating layer including a highly conductive carbon can be formed.

The liquid source of the hydrocarbon gas to use can be toluene, benzene, xylene, mesitylene, or the like, but it is particularly preferable to use toluene for easy handling. The hydrocarbon gas can be obtained by evaporating the liquid source (e.g., by bubbling with a nitrogen gas). Moreover, a methane gas or acetylene gas also can be used.

Also, when the granular material of the SiOₓ and the carbon material is produced, a dispersion in which the SiOₓ is dispersed in a dispersion medium is prepared and then sprayed and dried, thereby producing a granular material including a plurality of particles. The dispersion medium can be, e.g., ethanol. It is appropriate that the dispersion liquid is generally sprayed in an atmosphere at 50 to 300° C. Other than the method explained above, the granular material of the SiOₓ and the carbon material can be produced by a mechanical granulation method by using a vibrating or planetary ball mill, a rod mill, or the like.

When the average particle diameter of the material S is too small, the dispersibility of the material S could decrease so that sufficient effects of the present invention might not be obtained. In addition, the material S has a large volumetric change by the charge and the discharge of the battery, and therefore, when an average particle diameter is too large, the material S tends to be collapsed due to the expansion and the shrinkage (this phenomenon leads to a capacity deterioration of the material S). Therefore, it is preferably 0.1 μm or more and 10 μm or less.

The content of the material S in all the negative electrode active materials in the negative electrode composition layer can be preferably 10% or more, and more preferably 10 mass % or more, and further preferably 50 mass % or more. Since the material S can achieve a remarkably high capacity compared with graphite as explained before, any inclusion of the material S in the negative electrode active material even at a small quantity can bring about a capacity improvement effect of a battery. On the other hand, in order to remarkably make improvements of the high capacity of the battery, it is preferable that 10 mass % or more of the material S can be included in the total of the negative electrode active materials. Depending on the applications of the battery and its properties as demanded, the content of the material S can be adjusted. It is noted that the content ratio of the materials S in all of the negative electrode active materials can reach 100 mass % (i.e., all of the negative electrode active material is composed of the materials S.), but when it is used together with a negative electrode active material other than the material S, the content ratio of the materials S can be 99 mass % or less, and preferably 90 mass % or less, and more preferably 80 mass % or less.

In addition to the material S as explained above, the negative electrode can also include a carbon material such as graphite that can electrochemically store and release Li. When using graphite at the negative electrode and contemplating to control the reactivity with the propylene carbonate, the examples of preferable graphite to use can be a graphite in which the surface of natural graphite is coated with a resin, or a graphite in which the surfaces of the graphite particles are coated with amorphous carbon.

The detailed explanation is provided for the graphite in which the surfaces of the graphite particles are coated with amorphous carbon. That is, it is a graphite having an R value of 0.1 to 0.7, in which the R value is a peak strength ratio of the peak strength at 1340 to 1370 cm⁻¹ with respect to the peak strength at 1570 to 1590 cm⁻¹ by means of an argon ion laser Raman spectrum. It is preferable that the R value is 0.3 or more are more in order to secure sufficient quantity of the coating by the amorphous carbon. On the other hand, it is also preferable that the R value is 0.6 or less since an excess amount of the coating quantity of the amorphous carbon might increase the irreversible capacity. Such a graphite B can be obtained by as follows. For example, a base material of graphite (i.e., base particles) is provided which has a spherical shape made of natural graphite or artificial graphite having d₀₀₂ or 0.338 nm or less, whose surface is coated with an organic compound, followed by burning at 800 to 1500° C. Then, the matter is ground and then passed through a sieve to adjust the size of the granule. The examples of the organic compound coating the mother material can include aromatic hydrocarbon; kinds of tar or pitch obtained by performing condensation polymerization of an aromatic hydrocarbon under heat and pressure; kinds of tar, pitch or asphalt mainly composed of a mixture of aromatic hydrocarbons; and etc. As a method to coat the base material with the organic compound, there can adopt a method in which that the base material is impregnated into and mixed with the organic compound. An alternative method can be by means of a vapor phase method through thermolysis of hydrocarbon gas such as propane or acetylene carbon to make it into carbon to be deposited onto the surface of graphite having d₀₀₂ of 0.338 nm or less.

Furthermore, the graphite B as described above is high in Li ion receptivity (that can be shown, e.g., as a number representing a ratio of the constant current charge capacity with respect to the total charge capacity). Thus, a lithium ion secondary battery made by using graphite together has a good Li ion receptivity, thereby resulting in further improvements in the charge discharge cycle characteristic. As mentioned above, in case where Li ions are introduced into the negative electrode including the material S by means of electrochemical contact (i.e., short circuit), it is considered that if the graphite is used together, the disproportionation during the Li ion introduction could be controlled to contribute to improvements of the battery properties.

In addition, if the particle size of the graphite as explained above is too small, the specific surface area could be excessively increased (which could result in an increase of the irreversible capacity). Thus, it is preferable that the particle size thereof should not be too small. Therefore, it is preferable that the average particle diameter of the graphite is 8 μm or more.

It is noted that the term “the average particle diameter” regarding the graphites can be defined as follows. For example, a laser dispersion particle size distribution meter (e.g., a micro track particle size distribution measuring equipment, “HRA9320,” made by Nikkiso Co., Ltd.) is used. The graphite is dispersed in a media which does not dissolve or swell the graphite to measure a particle size distribution. Then, integral calculus volume is calculated from the smaller particles thereof. In this case, the term corresponds to the value (d_{50%}) median diameter of the 50% diameter of the multiplication fraction of the volume standard.

The specific surface area of the graphite can be measured as follows. (It is in accordance with a BET method. The example of the device to use can be “BELSORP MINI” by Nippon Bell Corporation.) can be preferably 1.0 m²/g or more, and can be preferably 5.0 m²/g or less.

In addition, the negative electrode active materials can include other negative electrode active material than the material S and the graphite as explained above, to the extent that it does not interfere the effects of the present invention.

The binder of the negative electrode composition layer can be selected in such a way that, for example, it is electrochemically inert to Li within the electrical potential range of the negative electrode and that it does not influence on the other components as much as possible.

In details, the suitable examples thereof can include styrene-butadiene rubber (SBR), polyvinylidene fluoride (PVdF), carboxymethylcellulose (CMC), polyvinyl alcohol (PVA), methylcellulose, polyamideimide, polyimide, polyacrylic acid, and the derivatives thereof and the copolymers thereof. These binders can be used alone, or two or more kinds thereof can be used in combination.

The negative electrode composition layer as mentioned above can further include a conductive material as a conductive assistant. Such a conductive material is not particularly limited so long as it does not cause a chemical reaction inside the battery. The examples can include carbon black (e.g., thermal black, furnace black, channel black, KETJEN black, acetylene black), carbon fibers, metal powders (e.g., powders of e.g., copper, nickel, aluminum, silver and etc.), metal fibers, polyphenylene derivatives (ones disclosed in Japanese Laid-Open Patent Publication No. S59-20971). These compounds can be used alone or in combination of two or more kinds. Among these examples, it is preferable to use carbon black, and KETJEN black and acetylene black are more preferable.

The negative electrode can be prepared as follows. For example, a negative electrode active material and a binder, as well as a conductive assistant if necessary, are dispersed into a solvent such as N-methyl-2-pyrrolidone (NMP) or water to prepare a composition containing a negative electrode composition (here, the binder may be dissolved in the solvent), which is then applied to one surface or both surface of a current collector. After drying, a calendar process is applied if necessary, so as to prepare a negative electrode. However, the method to prepare the negative electrode is not limited to the explanation above, and another method can be adopted to prepare it.

It is favorable that the thickness of the negative electrode composition layer is 10 to 100 μm per one side of the current collector. Also, the density of the negative electrode composition layer (which can be defined from a thickness, and a mass of the negative electrode composition layer per a unit area stacked on the current collector) is preferably 1.0 g/cm³ or more for the purpose to attain a high capacity of a battery. In addition, it is more preferably 1.2 g/cm³ or more. Also, it is found that adverse effects such as a drop of osmosis of the nonaqueous electrolyte liquid can be induced when the density of the negative electrode composition layer becomes too high, and therefore, it is preferably 1.6 g/cm³ or less. Regarding the composition of the negative electrode composition layer, for example, it is preferable that the quantity of the negative electrode active material is 80 to 99 mass %; it is preferable that the quantity of the binder is 0.5 to 10 mass %; and it is preferable that the quantity conductive assistant, if used, is 1 to 10 mass %.

As a supporting body (i.e., negative electrode current collector) to collect electric current of the negative electrode and support the negative electrode composition layer, for example, a foil made of copper or nickel can be used. Also, a foil, punched metal, mesh or expanded metal, made of copper or nickel can be used, which has a through hole as penetrating from one surface of the negative electrode current collector to the other surface thereof. Regarding the thickness of the negative electrode current collector, it is preferable that the upper limit is 30 μm, and that the lower limit is 4 μm in light of securing a mechanical strength. When using a foil without the through hole as a current collector, it can be possible to attain a larger contact area between the negative electrode composition layer and the negative electrode current collector, and therefore, even if the negative electrode composition layer expands or shrinks, its falling-off can be suitably prevented. In addition, a mechanical strength can be preferably secured.

In order to extend the cycle life or to prevent Li from precipitating on the surface of the negative electrode composition layer of the lithium ion secondary battery of the present invention, the negative electrode composition layer may have its surface forming a porous layer including an insulating material which does not react with Li.

The examples of the insulating material which does not react with Li can be of either an inorganic material or an organic material, which is not the particularly limited, but it is suitable to use an inorganic material such as, for example, alumina, silica, boehmite, and titania. In particular, a plate-like material having an aspect ratio of 5 or more can suitably orient the insulating material on the surface of the negative electrode composition layer such that the porous layer can be provided with moderate curved paths, thereby favorably preventing a micro short circuit phenomenon between the positive and the negative electrodes.

The porous layer can include the insulating material which does not react with Li as explained above, which can be formed by applying a dispersion in which the insulating material, a binder (e.g., a binder for a negative electrode as explained above), and a dispersant and a thickener, if necessary, are dispersed into a solvent on the negative electrode composition layer, followed by drying it. It is noted that the thickness of the porous layer is preferably 2 to 10 μm.

For example, the positive electrode of the lithium ion secondary battery of the present invention has a structure in which a positive electrode composition layer including a positive electrode active material, a conductive assistant and a binder is formed on one surface or both surfaces of the positive electrode current collector.

The positive electrode active material to be used as the positive electrode mentioned above is not particularly limited and can be an active material generally known, including e.g., lithium-containing transition metal oxide. For example, specific examples of the lithium-containing transition metal oxide can include LiₓCoO₂, LiₓNiO₂, LiₓMnO₂, LiₓCo_{y}Ni_{1-y}O₂, LiₓCo_{y}M_{1-y}O₂, LiₓNi_{1-y}M_{y}O₂, LiₓMn_{y}Ni_{z}Co_{1-y-z}O₂, LiₓMn₂O₄, and LiₓMn_{2-y}M_{y}O₄. In each of the structural formulae above, M is at least one metallic element selected from the group consisting of Mg, Mn, Fe, Co, Ni, Cu, Zn, Al, Ti, Ge and Cr, and satisfies 0≤x≤1.1, 0<y<1.0, 1.0<z<2.0.

It is characterized in that the materials S including the Si that can be used as the negative electrode active material of the present application shows a capacity of 1000 mAh/g or more, remarkably exceeding a theoretical capacity of graphite, that is to be said as 372 mAh/g. In addition, comparing the Li ion insertion electrical potential at the time of charge in case of conventional graphite, it has been found that the materials S including the Si has a low Li ion insertion electric potential at the time of the charge.

Generally speaking, lithium ion secondary batteries in most instances are charged with a constant current constant voltage charge (CC-CV) method. It is a method for charging a lithium ion secondary battery in which the charging starts at a constant current (i.e., CC charge) at the beginning, and when the battery reaches its charge upper limit voltage, the charge is continued in such a way to keep the constant voltage (i.e., CV charge). In the CV charge, the charge is carried out at a current value significantly lower than the current value at the CC charge. In the lithium ion secondary batteries of recent years, the charge upper limit voltage is often set up between 4.2 V to 4.7 V.

When the ratio of the materials S including Si in the negative electrode active material is set up at 5 mass % or more, the deposition of the Li could tend to occur more easily at the time of charge, which could bring about battery swollenness and capacity deterioration at the time of a high temperature storage. It is considered that this happens due to the reason below. When a lithium ion secondary battery is subject to the CC-CV charges, the desorption of the Li ions from the positive electrode at the time of the CC mode charge can be progressed such that its battery voltage is raised, and therefore, Li ions can be inserted in the material S without any problems at the beginning stage of the charge. However, when the CC mode charge is advanced and the battery voltage comes close to the charge upper limit voltage (i.e., the end stage of the CC mode), the electrical potential of the negative electrode comes close to 0 V, and it accepts Li ions while the deposition of Li can simultaneously occur. This deposition of Li can become a reaction active surface with the electrolyte liquid, and particularly when stored at a high temperature, it can react with the electrolyte liquid to generate gases, thereby bringing about the swollenness of the battery.

Then, it was found that it was preferable to increase the resistance of the positive electrode at the time of charge. The reasons thereof can be considered as follows: That is, the positive electrode electric potential can be raised at the CC mode while the battery voltage can be relatively raised, and therefore, the charge can be switched into the CV mode at a earlier stage, i.e., the end stage of the CC mode when the deposition of Li can tend to occur on the negative electrode. Then, the charge electric current can be decremented so as to lower the polarization. As a result, it is considered that the deposition of the Li can be restricted at the negative electrode.

In particular, when using a lithium cobalt oxide (LixCoO₂) as a positive electrode active material which surface is provided with an Al-containing oxide to thereby increase the resistance of the positive electrode at the time of charge, it can become possible to restrict the deposition of Li on the negative electrode. As a result, even if the ratio of the materials S is increased, it is possible to favorably provide a lithium ion secondary battery to restrict the battery swollenness and the capacity deterioration at a high temperature storage.

In addition, the Al-containing oxide with which the surface of the lithium cobalt oxide is coated can obstruct the lithium ions from inserting into or desorbing from the positive electrode active material. Therefore, for example, it might act to deteriorate the load characteristics of the battery. However, by specifying the average coating thickness of the Al-containing oxide into a specific value, the deterioration of the battery properties due to the coating of the Al-containing oxide can be also restricted. The lithium cobalt oxide provided in the positive electrode material can act as a positive electrode active material in the lithium ion secondary battery. The lithium cobalt oxide can be expressed as a composition formula, LiM^{a}O₂, where M^{a} inclusively refers to an element group including Co and the other elements that can be contained therein.

It is preferable that the lithium cobalt oxide includes at least one kind of element M¹ selected from the group consisting of Mg, Zr, Ni, Mn, Ti and Al. In the lithium cobalt oxide, the element M¹ can improve the stability at a high voltage region of the lithium cobalt oxide, and have an action to restrict the Co ions from elution while acting to improve the heat stability of the lithium cobalt oxide.

In the lithium cobalt oxide, in view of more effectively obtaining the actions above, the quantity of the element M¹ with respect to Co, that is, an atom ratio M¹/Co can preferably satisfy 0.003 or more, and more preferably it can satisfy 0.008 or more.

However, when the quantity of the element M¹ in the lithium cobalt oxide is excessive, the quantity of Co can become too little, and it might become uncertain whether to secure the actions from it. Thus, regarding the quantity of the element M¹ with respect to Co in the lithium cobalt oxide, the atom ratio M¹/Co can preferably satisfy 0.06 or less, and more preferably, it can satisfy 0.03 or less.

In the lithium cobalt oxide, Zr acts to adsorb the hydrogen fluoride that can be generated due to LiPF₆ included in the nonaqueous electrolyte liquid, thereby restricting the deterioration of the lithium cobalt oxide.

When a small amount of water is inevitably contaminated in the nonaqueous electrolyte liquid used in the lithium ion secondary battery, or when the other battery materials is at a state where water is adsorbed to, hydrogen fluoride can be generated through a reaction with LiPF₆ that is included in the nonaqueous electrolyte liquid. When hydrogen fluoride is generated inside the battery, its action can bring about the deterioration of the positive electrode active material.

However, when a lithium cobalt oxide including Zr is synthesized, a Zr oxide can be deposited on the surface of the particles, and the Zr oxide can adsorb the hydrogen fluoride. As a result, the deterioration of the lithium cobalt oxide due to the generation of hydrogen fluoride can be restricted.

In addition, the load characteristics of the battery can be improved when Zr is included in the positive electrode active material. It can be possible to use the lithium cobalt oxide included in the positive electrode material, which comprises two materials different in the average particle diameter from each other. Assume that the one having a larger average particle diameter is a lithium cobalt oxide (A); and assume that the other one having a smaller average particle diameter is a lithium cobalt oxide (B). Generally speaking, when using a positive electrode active material having a large particle diameter, it can tend to reduce the load characteristics of the battery. Therefore, among the positive electrode active materials constituting the positive electrode material of the present invention, it is preferable to include Zr in the lithium cobalt oxide (A) having such a larger average particle diameter. On the other hand, the lithium cobalt oxide (B) may or may not include Zr therein.

In the lithium cobalt oxide, the quantity of the element Zr with respect to Co, that is, an atom ratio Zr/Co can preferably satisfy 0.0002 or more, and more preferably it can satisfy 0.0003 or more in view of more favorably obtaining the actions above. However, when the quantity of Zr in the lithium cobalt oxide is excessive, the quantity of the other elements can become too little and it might become uncertain if the actions from them can be secured. Therefore, regarding the quantity of the element Zr with respect to Co in the lithium cobalt oxide, the atom ratio Zr/Co can preferably satisfy 0.005 or less, and more preferably, it can satisfy 0.001 or less.

The lithium cobalt oxide can be prepared by mixing a Li-containing compound (e.g., lithium hydroxide, lithium carbonate), a Co-containing compound (e.g., cobalt oxide and cobalt sulfate), and a compound containing an element M¹ (e.g., oxides such as zirconium oxide, hydroxides, and sulfates such as magnesium sulfate) to obtain a raw material mixture, followed by burning it to be synthesized. In addition, in order to synthesize a lithium cobalt oxide with a higher purity, it is preferable that a complex compound containing Co and the element M¹ (e.g., hydroxides and oxides) is mixed with e.g., a Li-containing compound so as to obtain a raw material mixture, followed by burning it.

The burning condition of the raw material mixture to synthesize the lithium cobalt oxide can be, for example, at 800 to 1050° C. for 1 to 24 hours. However, it is preferable that at a first stage, it is heated to a temperature that is lower than the burning temperature (e.g., 250 to 850° C.) and kept at the temperature to carry out a preliminary heating, and then, it is raised to the burning temperature to make the reaction progress. The time to continue the preliminary heating is not particularly limited, but it can be generally carried out for a period of 0.5 to 30 hours. Also, the atmosphere of the burning can be an atmosphere including oxygen (namely, in the atmosphere), a mixed atmosphere of an inert gas (e.g., argon, helium and nitrogen) and an oxygen gas, or an oxygen gas atmosphere. In this case, it is preferable that the oxygen concentration can be 15% or more (volume standard), and it is more preferable that it can be 18% or more.

The examples of the Al-containing oxide with which the surface of the particles of the lithium cobalt oxide is coated can include Al₂O₃, AlOOH, LiAlO₂, LiCo_{1-w}Al_{w}O₂ (wherein 0.5<w<1), and one kind of these can be used alone, or two or more kinds can be used in combination. In addition, when the surface of the lithium cobalt oxide is coated with Al₂O₃ by means of the method explained later, the coating film thus formed can be of Al₂O₃ which can partly include an Al-containing oxide containing an element such as Co and Li as a result of moving from the lithium cobalt oxide. Therefore, such a coated film can be within the scope as the coating film including an Al-containing oxide to cover the surface of the lithium cobalt oxide to constitute the positive electrode material.

The average coating thickness of the Al-containing oxide in the particles constituting the positive electrode material can be defined in view of the two aspects below: one is to increase the resistance by the action of the Al-containing oxide that can obstruct the lithium ions from being inserted in or released from the positive electrode active material of the positive electrode material during the charge and the discharge of the battery, thereby to improve the charge discharge cycle characteristics of the battery by restricting the Li deposition at the negative electrode; and the other is to favorably control the reaction of the positive electrode active material in the positive electrode material with the nonaqueous electrolyte liquid. In view of the aspects above, it is preferable 5 nm or more, and more preferably 15 nm or more. In addition, the average coating thickness of the Al-containing oxide can be defined in view of restricting the deterioration of the load characteristics of the battery by the action of the Al-containing oxide which can obstruct the lithium ions from being inserted into and released from the positive electrode active material in charging and discharging the battery. In view of the above, the average coating thickness of the Al-containing oxide in the particles constituting the positive electrode material can be preferably 50 nm or less, and more preferably 35 nm or less.

In the specification of the present application, the feature that “the average coating thickness of the Al-containing oxide in the particles constituting the positive electrode material” can be measured as follows. That is, a cross section of the positive electrode material obtained by the process of a convergence ion beam method is magnified 400,000 times by using a transmission electron microscope, to thereby observe the positive electrode material particles within a field of vision of 500×500 nm. The same measurement is carried out at ten fields of the vision that are arbitrarily selected. In each field of the vision, ten places are arbitrarily selected to measure the thickness of the coating film of the Al-containing oxide, each having a cross section that is equal or less than the average particle diameter (d₅₀) ±5 μm, and a thickness of the coating film of the Al-containing oxide is measured for ten times within the each vision. Then, the thickness of the coating film of the Al-containing oxide is obtained as an average (i.e., averaged number) of the values obtained by measuring the thicknesses at the whole fields of the visions (i.e., the thickness at 100 places).

The positive electrode material has a specific surface area (i.e., specific surface area of the whole positive electrode materials), which is preferably 0.1 m²/g or more, and more preferably, 0.2 m²/g or more. It is also preferably 0.4 m²/g or less, and more preferably, 0.3 m²/g or less. By defining the specific surface area of the positive electrode material within the range mentioned above, the resistance of the positive electrode material at the charge and the discharge of the battery can be increased and also restrict the Li deposition. Also in view of the action above, the swollenness and the capacity deterioration of the battery at a high temperature storage can be restricted.

In addition, when the surface of the particles of the positive electrode active material constituting the positive electrode material is coated with an Al-containing oxide, or when it is constituted to make a Zr oxide deposition on the surface of the particles of the positive electrode active material, the surface of the positive electrode material can be usually made coarse, thereby increasing a specific surface area. Therefore, in addition to making the positive electrode material have a relatively large particle size, when it is good enough to have a property of the coating film of the Al-containing oxide with which the surface of the particles of the positive electrode active material is coated, the specific surface area can become small as mentioned above, and therefore, it is considered preferable.

The lithium cobalt oxide included in the positive electrode material can be made of one kind, or two kinds of materials each having a different average particle diameter from each other as described above, or three or more kinds of materials each having a different average particle diameter to each other.

In order to adjust the positive electrode material within the range of the specific surface area as mentioned above (i.e., specific surface area of the whole positive electrode materials), it is preferable that the positive electrode material has a average particle diameter of 10 to 35 μm when using one kind of lithium cobalt oxide.

When the lithium cobalt oxide included in the positive electrode material includes two kinds of material, each different in the average particle diameter from each other, it is preferable to include at least a positive electrode material (a) and a positive electrode material (b); the positive electrode material (a) includes particles of the lithium cobalt oxide (A) which surfaces are coated with an Al-containing oxide and has an average particle diameter of 1 to 40 μm; the positive electrode material (b) includes particles of the lithium cobalt oxide (B) which surfaces are coated with an Al-containing oxide and has an average particle diameter is 1 to 40 μm, in which the average particle diameter of the positive electrode material (b) is smaller than that of the positive electrode material (a). Furthermore, it is preferable to constitute larger particles having an average particle diameter of 24 to 30 μm [i.e., positive electrode material (a)], and smaller particles having an average particle diameter of 4 to 8 μm [i.e., positive electrode material (b)]. In addition, it is preferable that the ratio of the larger particles in all the positive electrode materials can be 75 to 90 mass %.

In this way, not only adjusting the specific surface area, but the positive electrode material with the smaller particle diameter can enter the gap of the positive electrode material with the larger particle diameter through the press work process of the positive electrode composition layer. As a result, the stress applied to the positive electrode composition layer can be entirely spread out, and therefore, the particles of the positive electrode material can be favorably restricted from cracking and the actions from the formation of the coating film of the Al-containing oxide can be favorably expected.

As explained above, the positive electrode active material to be used as the positive electrode of the present invention is not particularly limited, and can be any active material generally known, including e.g., lithium-containing transition metal oxide. In addition, it is possible to use another lithium cobalt oxide other than one in which the surface of the lithium cobalt oxide is formed of the Al-containing oxide as explained before. However, when another lithium cobalt oxide other than one in which the surface of the lithium cobalt oxide is formed of the Al-containing oxide is used for the purpose of increasing the resistance of the positive electrode at the time of charging, it is preferable that the positive electrode composition layer includes an Al-containing oxide such as alumina and boehmite therein.

The conductive assistant used for the positive electrode mentioned above should be one which is chemically stable in the battery. The examples thereof can include: graphite such as natural graphite and artificial graphite; carbon black such as acetylene black, KETJEN BLACK (brand name), channel black, furnace black, lampblack and thermal black; conductive fiber such as carbon fiber and metal fiber; metallic powder such as aluminum flakes; fluorocarbon; zinc oxide; conductive whisker such as potassium titanate; conductive metal oxide such as titanium oxide; and organic conductive material such as polyphenylene derivatives; and these compounds can be used alone or in combination of two or more. Among these compounds, it is preferable to use graphite as it has a high conductivity, or carbon black as it has a superior liquid-absorbing property. Also, the form of the conductive assistant is not necessarily of a primary particle, but can be in aggregates such as a second aggregate or a chain structure. These aggregates are easy in handling and can improve the productivity, as well.

In addition, a binder of the positive electrode composition layer such as PVdF, P(VDF-CTFE), polytetrafluoroethylene (PTFE) and SBR can be used.

The positive electrode, for example, can be prepared as follows: The positive electrode active material, a conductive assistant, a binder and etc. are dispersed in a solvent such as N-methyl-2-pyrrolidone (NMP) to prepare a composition containing a positive electrode composition in a paste or slurry state (here, the binder may be dissolved in the solvent), which is then applied on one surface or both surfaces of a current collector, followed by drying, and then, a calendar process is applied if necessary. However, the preparation method of the positive electrode is not limited thereto, and the other methods can be adopted to prepare it.

It is preferable that the thickness of the positive electrode composition layer can be, for example, 10 to 100 μm on one side of the current collector. Regarding the composition of the positive electrode composition layer, for example, it is preferable that the quantity of the positive electrode active material can be 65 to 95 mass %; it is preferable that the quantity of the binder is 1 to 15 mass %; and it is preferable that the quantity conductive assistant is 3 to 20 mass %. Also, in the same manner as the negative electrode, a porous layer including an insulating material which does not react with Li can be formed on the surface of the positive electrode composition layers for the purpose of improving a battery performance such as charge discharge cycle characteristics.

The positive electrode current collector can be made of, for example, a foil of aluminum. Also, a foil, punched metal, mesh or expanded metal, made of aluminum can be used, which has a through hole as penetrating from one surface of the positive electrode current collector to the other surface thereof. Regarding the thickness of the positive electrode current collector, it is preferable that the upper limit thereof can be 30 μm, and that the lower limit thereof can be 4 μm in view of securing a mechanical strength.

Also, the positive electrode can be provided with a lead body for connecting it to other members inside the lithium secondary battery electrically, if necessary, which can be attached by a known method.

A separator used in the lithium ion secondary battery of the present invention is preferably a porous film made of, for example, polyolefin such as polyethylene, polypropylene, or ethylene-propylene copolymer; or polyester such as polyethylene terephthalate or copolymerized polyester. In addition, it is preferable that the separator can be provided with a property to be able to close its pores at 100 to 140° C. (i.e., shutdown function). For this purpose, the separator preferably includes a thermoplastic resin having a melting temperature of 100 to 140° C. as its component. In this case, the melting temperature can be measured by means of a differential scanning calorimeter (DSC) in accordance with Japanese Industrial Standards JIS K 7121. The separator is preferably a single-layer porous film made of polyethylene as a main component, or a laminated porous film made of two to five layers of polyethylene and polypropylene. When mixing polyethylene with a resin such as polypropylene having a higher melting point than polyethylene, or laminating the two resins, polyethylene can be desirably included at 30 mass % or more, and it can be more desirably included at 50 mass % or more, in the resins making up the porous film.

For such a resin porous film, there can be used, for example, a porous film made of any of thermoplastic resins mentioned above and used in conventionally-known lithium ion secondary batteries and the like, that is, an ion-permeable porous film produced by solvent extraction, dry drawing, wet drawing, or the like.

The average pore diameter of the separator can be preferably 0.01 μm or more, and more preferably 0.05 μm or more, and on the other hand, it can be preferably 1 μm or less, and more preferably 0.5 μm or less.

In addition, regarding the characteristics of the separator, it can be desirable if it has a Gurley value of 10 to 500 sec. Here, the Gurley value can be obtained by a method according to JIS P 8117 and expressed as the number of seconds it takes for 100 ml air to pass through a membrane at a pressure of 0.879 g/mm². If the air permeability is too large, the ion permeability may be decreased, and on the other hand, if the air permeability is too small, the strength of the separator may be decreased. Furthermore, it is desirable that the separator has a strength of 50 g or more, in which the strength can be a piercing strength obtained by using a needle having a diameter of 1 mm. If the piercing strength as explained above is too small, the dendrite crystals of lithium may be produced to penetrate the separator, thereby causing a short circuit.

The separator to be used can be a laminate type separator having a porous layer (I) mainly composed of a thermoplastic resin, and a porous layer (II) mainly composed of fillers having a heat resistant temperature of 150° C. or more. The separator above can be provided with properties of a shut-down function, a heat resistance (i.e., heat resistant shrinkage) and a high mechanical strength. Accordingly, the separator above can be expected to have a high mechanical strength to provide with a high resistance against the expansion or shrinkage of the negative electrode caused by the charge discharge cycles, while the separator can be also expected to be restricted from being twisted to maintain the cohesiveness among the negative electrode, the separator and the positive electrode.

In the specification of the present application, the feature of “heat-resistant temperature of 150° C. or more” means not to start a transformation such as softening at least at a temperature of 150° C.

The porous layer (I) included in the laminated type separator is a layer to be provided to mainly ensure the shutdown function, and therefore, if the battery reaches the melting point of the resin, i.e., the main component of the porous layer (I), the resin contained in the porous layer (I) may melt to close the pores of the separator, thereby causing a shutdown effect that suppresses the progress of the electrochemical reaction.

Regarding thermoplastic resin mainly constituting the porous layer (I), the examples thereof can preferably include a resin having a melting point of 140° C. or less, such as polyethylene. Here, the melting temperature can be measured by using a differential scanning calorimeter (DSC) in accordance with the standard defined in JIS K 7121. The examples of the porous layer (I) can include a microporous film that is usually used as a separator of a lithium secondary battery, and a sheet obtained by applying a dispersion containing polyethylene particles on a substrate such as a non-woven fabric, followed by making the substrate dried. Here, in the total of the constituent components of the porous layer (I) (here, it is the total volume excluding the cavity potions; and the same explanation applies to the content ratio by volume of the components of the porous layer (I) and the porous layer (II)), it is preferable that the content ratio by volume of the thermoplastic resin as a main component can be 50 volume % or more, and more preferably 70 volume % or more. It is noted that in a case where the porous layer (I) is a polyethylene microporous film, the volume content of the thermoplastic resin can be 100 volume %.

The porous layer (II) included in the separator can act a function to prevent a short-circuit caused by direct contact between the positive electrode and the negative electrode, even if the internal temperature of the battery is raised. This function can be ensured by fillers having a heat resistance temperature of 150° C. or more. In other words, when the battery temperature is raised high and even if the porous layer (I) shrinks, the porous layer (II) is less susceptible to shrinkage so that it can prevent a short-circuit caused by direct contact between the positive and negative electrodes, though it could occur as a result of thermal shrinkage of the separator without it. Also, the heat resistant porous layer (II) acts as a framework for the separator, and therefore thermal shrinkage of the porous layer (I), or in other words, the overall thermal shrinkage of the separator can be suppressed as well.

The fillers of the porous layer (II) can be either of organic particles or inorganic particles, so long as they have a heat resistant temperature of 150° C. or more and are stable in the electrolyte liquid included in the battery, and furthermore are electrochemically stable and difficult to cause a redox reaction within the range of the battery operation voltage. They are preferably of fine particles in view of dispersibility. In addition, they are preferably of inorganic oxide particles, which are in particular made of alumina, silica or boehmite. Alumina, silica and boehmite are high in their oxidation resistance and are capable of adjusting their particle sizes and shapes within a range of desired numerical values, so that the cavity rate of the porous layer (II) can be precisely controlled. The fillers having a heat resistant temperature of 150° C. or more can be used alone or in combination of two or more kinds.

As the nonaqueous electrolyte liquid to be used in the lithium ion secondary battery of the present invention, it is possible to use a nonaqueous electrolyte liquid in which a lithium salt is dissolved in an organic solvent.

The organic solvent used in the nonaqueous electrolyte liquid mentioned above can include at least propylene carbonate (PC). The volume of the propylene carbonate ratio in the whole organic solvents can be 10 to 50 volume %. Generally, the lithium ion secondary batteries includes ethylene carbonate (EC) mainly used as an organic solvent. However, in the case of a lithium ion secondary battery using a negative electrode which includes 5 mass % or more of materials S in the negative electrode active material, a decomposition reaction of ethylene carbonate could occur relatively actively, thereby generating a large amount of gases. In particular, gas generation has been significantly found when a battery was stored at a high temperature of 60° C. or more for a certain period of time. Then, it has been found to restrict gas generation by using propylene carbonate, i.e., a cyclic carbonate similar to ethylene carbonate, as an organic solvent so that the storage swollenness of the battery can be remarkably improved.

The nonaqueous electrolyte liquid to be used in the present invention can include propylene carbonate at 10 to 50 volume % in the whole organic solvents. Within the range mentioned above, it is possible to restrict gas generation while maintaining a high cycle characteristics.

As a solvent of the nonaqueous electrolyte liquid, a chain carbonate can be used in addition to propylene carbonate. As a result, it is possible to obtain a nonaqueous electrolyte liquid having a high conductivity so that the battery properties can be made well. The examples of the chain carbonate can include dimethyl carbonate (DMC), diethyl carbonate (DEC) and methylethyl carbonate (MEC). In addition to the solvent of the nonaqueous electrolyte liquid, another organic solvent can be used together. The examples thereof can include cyclic carbonates such as ethylene carbonate, butylene carbonate; fluorine-substituted cyclic carbonates such as 4-fluoro-1,3-dioxolane-2-one (FEC); chain esters such as methyl propionate; cyclic esters such as γ-butyrolactone; chain ethers such as dimethoxyethane, diethyl ether, 1,3-dioxolane, diglyme, triglyme, and tetraglyme; cyclic ethers such as dioxane, tetrahydrofuran, and 2-methyltetrahydrofuran; nitriles such as acetonitrile, propionitrile and methoxypropionitrile; and sulfurous esters such as ethylene glycol sulfite. These organic solvents that can be also used as a mixture of two or more kinds.

The lithium salt used for the non-aqueous electrolytic solution is not particularly limited as long as it dissociates in the solvent to produce a lithium ion and is not likely to cause a side reaction such as decomposition in the working voltage range of the battery. Examples of the lithium salt include inorganic lithium salts such as LiClO₄, LiPF₆, LiBF₄, LiAsF₆, and LiSbF₆, and organic lithium salts such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≤n≤7), and LiN(RfOSO₂)₂ (where Rf represents a fluoroalkyl group).

The concentration of the lithium salt in the non-aqueous electrolytic solution is preferably 0.5 to 1.5 mol/L, and more preferably 0.9 to 1.25 mol/L.

In addition, the nonaqueous electrolyte liquid can further contain additives in view of making further improvement in the charge discharge cycle characteristics or for the purpose to improve the safety features such as high temperature storage property and overcharge prevention property; and the examples of the additives in these purposes can include vinylene carbonate, vinylethylene carbonate, anhydrous acid, sulfonate, dinitrile, 1,3-propanesultone, diphenyl disulfide, cyclohexylbenzene, biphenyl, fluorobenzene, t-butylbenzene, phosphonoacetate compounds, and 1,3-dioxane (derivatives thereof can be included).

Furthermore, the nonaqueous electrolyte liquid can also contain known gelatification agents such as a polymer, so that it can be provided in a gel state (i.e., gelled electrolyte).

In case of the lithium ion secondary battery of the present invention, consider the situation about the time when it is discharged at an discharge current rate of 0.1 C to reach a voltage of 2.0 V, with respect to all the positive electrode active material included in the positive electrode (The positive electrode material coated with the Al-containing oxide can be included. The same notion is applied to the later explanation.). At the situation above, it is preferable that a molar ratio (Li/M) of Li and the other metal M than Li can be 0.8 to 1.05. As described before, in case where a negative electrode active material such as material S having a high irreversible capacity is used in the negative electrode, there can be found a phenomenon that the Li ions that are able to return to the side of the positive electrode in the discharge are significantly reduced, after the Li ions released from the positive electrode has moved to the side of the negative electrode during the charge. Therefore, in accordance with the previous description, if Li ions are introduced into the negative electrode composition layer in advance, the capacity of the positive electrode can be completely used during the discharge of the battery, thereby increasing the capacity of the battery. The range of the (Li/M) as being 0.8 to 1.05, mentioned above, can be accomplished by introducing Li ions into the negative electrode composition layer including the materials S as explained before.

Also, the composition analysis of the positive electrode active material at the time when it is discharged to reach the voltage of 2.0 V at a discharge current rate of 0.1 C can be carried out by means of ICP (i.e., Inductive Coupled Plasma) method as follow. First, 0.2 g of a positive electrode active material as a measurement target is taken out and put into a 100 mL container. Then, 5 mL of pure water, 2 mL of aqua regia, and 10 mL of pure water are sequentially added in the order to cause a heat solution, followed by cooling and diluting 25 times with pure water. An ICP analyzer, “ICP-757” manufactured by JARRELASH Co., Ltd. is used to carry out a composition analysis by a calibration curve method. The quantities of the composition can be identified from the results as obtained.

An example of the Li/M can be explained with reference to Example 1 described later. Example 1 uses a positive electrode material (a1) having formed a coating film of an Al-containing oxide on the surface of LiCo_{0.9795}Mg_{0.011}Zr_{0.0005}Al_{0.009}O₂, that is, a lithium cobalt oxide (A1), and a positive electrode material (b1) having formed a coating film of an Al-containing oxide on the surface of LiCo_{0.97}Mg_{0.012}Al_{0.009}O₂, that is, a lithium cobalt oxide (B1). In this case, the metal M other than Li refers to Co, Mg, Zr and Al. In other words, after preparing a lithium ion secondary battery and after subjecting to predetermined charge discharge processes, the battery is disassembled to take out the positive electrode material (i.e., a mixture in Example 1) from the positive electrode composition layer, which is then analyzed to obtain the Li/M.

The examples of the methods to introduce Li ions into the negative electrode composition layer by means of an intrasystem pre-dope method can include: a method in which a Li source contacts the negative electrode as described before; a method in which a nonaqueous electrolyte liquid is filled with and a charge discharge process is applied in a condition where the negative electrode comes in contact with a Li source by a know method, for example, by attaching a Li foil to the negative electrode composition layer, or by adding Li particles into the negative electrode composition layer, or by making Li vapor-deposition onto the surface of the negative electrode; and a method in which a negative electrode and a Li source are configured not to make contact with each other, and then, the battery is filled with a nonaqueous electrolyte liquid, followed by applying a charge discharge process through an outside connection.

In conventional lithium ion secondary batteries, it is possible to use a stacked body (i.e., stacked electrode body) including a negative electrode and a positive electrode with an intervention of a separator therebetween, or to use a winding body (i.e., winding electrode body) by winding the stacked body into an eddy form. Comparing the stacked electrode body with the winding electrode body, the former can be easier to keep the distance between the positive electrode and the negative electrode even if the volume of the negative electrode is changed upon charge and discharge of the battery, and therefore, the battery properties can be well maintained. For these reasons, it is desirable to use a stacked electrode body in the lithium ion secondary battery of the present invention.

When the electrode body is a stacked electrode body if the Li source is disposed at the end face of the stacked electrode body to introduce Li ions into negative electrode, Li ions can be prevented from being excessively introduced into one particular negative electrode locally. As a result, the negative electrode composition layer can be prevented from falling off from the negative electrode current collector while the distance between each negative electrode and the Li source can be maintained constant, so that it is possible to restrict a negative electrode from receiving extremely given damages due to the expansion. As a result, it is possible to control the deterioration of the charge discharge cycle characteristic.

Next, one embodiment is explained with reference to a lithium ion secondary battery including a stacked electrode body and a Li source. For example, the stacked electrode body has stacked a positive electrode and a negative electrode with intervention of a separator, and Li is provided at the end face of the stacked electrode body not face the composition layer, and a third electrode electrically connected to the negative electrode is provided. The Li of the third electrode is provided in order to use it as a Li source to introduce Li into negative electrode composition layer.

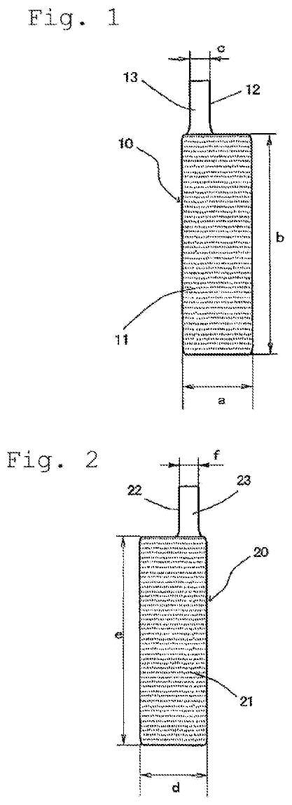

Then, the stacked electrode body is explained. Each of FIGS. 1 and 2 schematically shows a plan view of a positive electrode 10 or a negative electrode 20. The positive electrode 10 has a positive electrode composition layer 11 applied on both surfaces of the positive electrode current collector 12, i.e., a metal foil of aluminum. Also, the positive electrode 10 has a positive electrode tab part 13. Also, the negative electrode 20 has a negative electrode composition layer 21 applied on both surfaces of the negative electrode current collector 22, i.e., a metal foil of copper. Also, the negative electrode 20 has a negative electrode tab part 23.

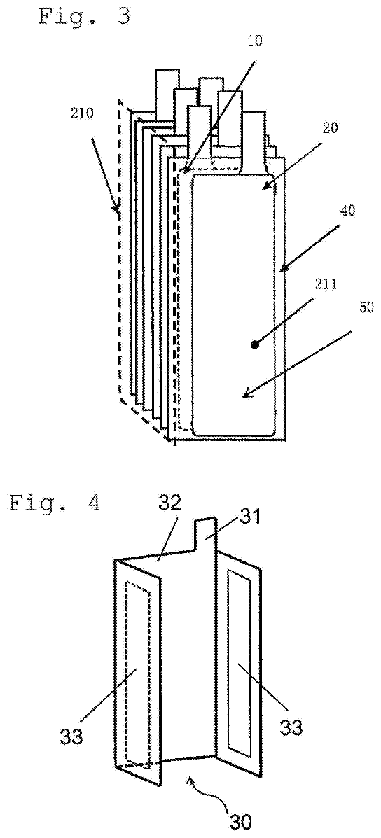

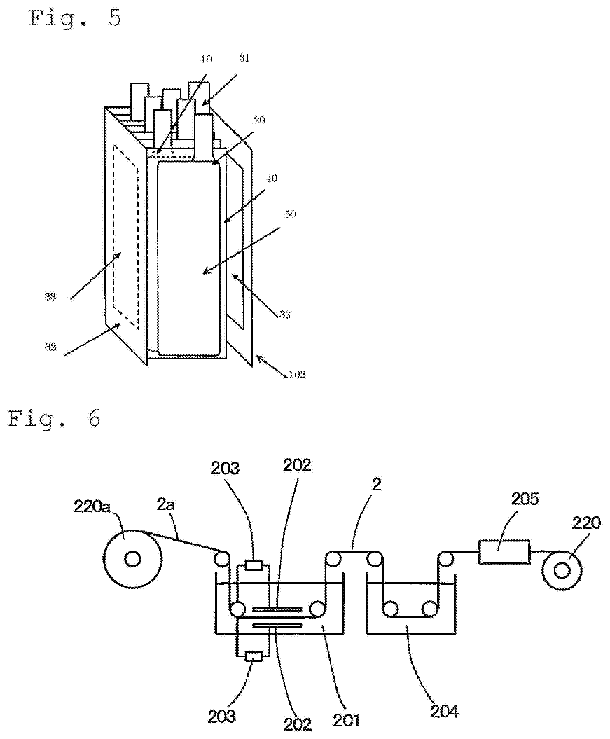

FIG. 3 shows one example of the stacked electrode body 50. The stacked electrode body is formed by stacking the positive electrode and the negative electrode with an intervention of the separator, as illustrated by stacking negative electrode 20, separator 40, positive electrode 10, separator 40, negative electrode 20, and etc. Here, the surface that is parallel to the stacking direction of the stacked electrode body is called as the end face of the stacked electrode body (which can correspond to, for example, e.g., the hypothetical surface 210 shown by dotted lines in FIG. 3), and the surface that is perpendicular to the stacking direction of the stacked electrode body is called as the plain surface (which can correspond to the surface 211 in FIG. 3) of the stacked electrode body. In the stacked electrode body 50 to shown in FIG. 3, one sheet of the separator 40 is each provided between the positive electrode and the negative electrode, but an alternative embodiment can be provided by folding a strip shape of a separator in a shape of Z character, inside the gap of which the positive electrode and the negative electrode are inserted. Also, the number of each electrode are not limited to three such as the example shown in FIG. 3. Furthermore, plural positive electrode tab parts and plural negative electrode tab parts can be each connected to the positive electrode external terminal and the negative electrode external terminal, but such a configuration is omitted in FIG. 3 (as well as FIG. 5 described later).

In FIG. 3, only one end face and only one plain surface of the stacked electrode body 50 are illustrated, but the invention is not limited thereto. For example, there can exist another end face of the stacked electrode body at the opposite surface of the hypothetical surface shown by the dotted line in FIG. 3, and the same is true for the plain surface of the stacked electrode body. The end face of the stacked electrode body is plain as shown in FIG. 3, but it can be curved depending on the shape of the electrode. The plain surface of the stacked electrode body can correspond to one surface of one of the positive electrode, negative electrode and separator.

FIG. 4 schematically shows a perspective view of an example of the third electrode 30 in order to introduce Li ions into the negative electrode composition layer. Third electrode 30 has a third electrode current collector 32 and a Li source 33. The third electrode current collector 32 shown in FIG. 4 has a third electrode tab part 31.

FIG. 5 is a perspective view showing an electrode body which is in an assembled condition of the stacked electrode body 50 with the third electrode 30. In electrode body 102, the third electrode current collector 32 is folded in an alphabet character “C” in such a manner that the two end faces, opposite to each other, of the stacked electrode body 50 are surrounded. Here, the Li source 33 is attached to the third electrode current collector 32 such that it is disposed as opposed to the end face of the stacked electrode body 50. In other words, the third electrode 30 is arranged at least at the end face of the stacked electrode body. In FIG. 4 and FIG. 5, the Li source 33 is arranged in both the end faces of the third electrode current collector 32, but only one can be arranged at one end face, or it can be arranged at an end face of an upper part (i.e., the upper part of the drawing) of the stacked electrode body 50, or at an end face of a lower part (i.e., the lower part of the drawing).

Furthermore, by adopting a metal foil without through holes as current collectors of the positive electrode and the negative electrode, an improvement of the strength can be expected compared with the case where the current collector having a through hole. In case of a negative electrode current collector, the adhesion area with the composition layer can be increased to contribute to the restraint of the falling off the negative electrode composition layer.

The third electrode can be prepared as follow: For example, there is provided a current collector made of e.g., copper or nickel, that is in a shape of a metal foil (which can be an embodiment with a through hole to penetrate from one surface thereof to the other surface thereof), punched metal, mesh or expanded metal. An appropriate quantity of a Li foil can be pressed and attached to the third electrode current collector. Alternatively, it is of course possible to prepare it by pressing a Li foil to attach it to the third electrode current collector, before the third electrode current collector can be cut out to provide with a predetermined quantity of Li, thereby obtaining a third electrode.

With respect to the third electrode having pressed the Li to attach it to the third electrode current collector, for example, the tab part of the third electrode current collector can be welded to the tab part of the negative electrode of the stacked electrode body, thereby accomplishing an electrical connection with the negative electrode of the stacked electrode body. So long as the third electrode is electrically connected to the negative electrode of the stacked electrode body, there is no limitation of the technique or formation, and any method other than the welding can be adopted to accomplish the electrical connection.

As explained before, the examples of the outside-system pre-dope method to incorporate Li ions into the negative electrode composition layer can include a method in which the negative electrode is added into a metal lithium solution (e.g., a solution which has dissolved a polycyclic aromatic compound and metal Li in a solvent such as an ether) so as to dope Li ions (i.e., a solution method); and a method in which both the negative electrode (i.e., an action pole) and a lithium metal pole (i.e., an opposite pole lithium metal foil or a lithium alloy foil can be used) are immersed in a nonaqueous electrolyte liquid, followed by making an electric conduction therebetween (i.e., a lithium metal electric conduction method). Also, it is preferable to adopt a roll-to-roll method to introduce Li ions into the negative electrode composition layer by means of an outside-system pre-dope method as explained before.

FIG. 6 is an illustrative drawing of the process to dope the negative electrode composition layer of the negative electrode with Li ions by means of a roll-to-roll method. At first, a roll 220a is provided by winding a negative electrode 2a to be doped with Li ions, and a negative electrode 2a is drawn from the roll and introduced into an electrolyte liquid bath 201 in order to dope it with Li ions. The electrolyte liquid bath 201 is provided with an nonaqueous electrolyte liquid (not shown in the drawing) and a lithium metal pole 202 such that the power supply 203 can make an electric conduction between the negative electrode 2a passing through the electrolyte liquid bath 201 and the lithium metal pole 202. Then, while the negative electrode 2a passes through the electrolyte liquid bath 201 as opposed to the lithium metal pole 202 and when the electric conduction is made by the power supply 203 between the negative electrode 2a and the lithium metal pole 202, the negative electrode composition layer of negative electrode 2a can be doped with Li ions.

After the negative electrode composition layer is doped with Li ions and passed through the electrolyte liquid bath 201, the negative electrode 2 (that has been doped with Li ions) is wound into a roll 220, preferably after it is washed. For example, the negative electrode 2 can be washed by passing the negative electrode 2 through the washing tank 204 filled with an organic solvent for washing, as shown in FIG. 6. It is also preferable that the negative electrode 2 passed through the washing tank 204 is then passed through a dry means 205, before it is wound off to a roll 220. There is no particular method to dry it at the dry means 205, so long as the organic solvent is removed from the negative electrode 2 attached at the washing tank 204. Various examples thereof can include, for example, a method with warm air or an infrared rays heater, and a method in which it is passed through an inert gas at a dry state.

In addition, the electrolyte liquid bath 201 shown in FIG. 6 is provided with two lithium metal poles 202 such that the negative electrode of the negative electrode composition layers formed on both surfaces of the negative electrode current collector can be doped with Li ions concurrently with respect to the both of the negative electrode composition layers. However, when Li ions are doped into a negative electrode composition layer of a negative electrode in which the negative electrode composition layer is formed on only one surface of the negative electrode current collector, the electrolyte liquid bath can be provided with only one lithium metal pole to be opposed with the negative electrode composition layer.

Thereby obtained negative electrode having its negative electrode composition layer doped with Li ions can be cut into a size as needed, and is provided to later production processes of lithium ion secondary batteries. Also, the negative electrode can be provided with a lead body for electrically connecting it to other members of the lithium ion secondary battery, if necessary, which can be attached by a known method.

Regarding the exterior body of the lithium ion secondary battery of the present invention, it is preferable to use a metal laminate film exterior body. The metal laminate film exterior body can be transformed more easily than. e.g., a metal can, and therefore, even if the negative electrode is expanded in the battery charge, it can prevent the negative electrode composition layer and the negative electrode current collector from breakage.

Regarding the metal laminate film constituting the metal laminate film exterior body, the examples thereof can include a metal laminate film made of a three laminate structure including an exterior resin layer, a metal layer and an interior resin layer in order.

Regarding the metal layer of the metal laminate film, the examples can include an aluminum film and a stainless steel film. Regarding the interior resin layer, the examples can include a film made of a thermal fusion bonding resin (e.g., a modified polyolefin ionomer showing a thermal fusion bonding property at a temperature of around 110 to 165° C.). Regarding the exterior resin layer of the metal laminate film, the examples can include a nylon film (e.g., 66 nylon film), a polyester film (e.g., polyethylene terephthalate film).

Regarding the metal laminate film, the metal layer preferable has a thickness of 10 to 150 μm, the interior resin layer preferably has a thickness of 20 to 100 μm, and the exterior resin layer preferably has a thickness of 20 to 100 μm.

There is no particular limitation to the shape of the exterior body. The examples thereof can include a polygon shape such as triangle, quadrangle, pentagon, hexagon, heptagon and octagon in a plain view. Generally, the shape is quadrangle (e.g., a rectangle or a square) in a plain view. In addition, there is no particular limitation to the size of the exterior body, and various kinds with a size such as so-called a light form or large form can be used.

The metal laminate film exterior body can be constituted by e.g., folding a single sheet of a metal laminate film into two layers, or stacking two sheets of metal laminate films.

In addition, in the case where the the exterior body in its plain view is a polygon, the side where a positive electrode external terminal is provided can be either the same as, or different from, the side where a negative electrode external terminal is provided.

It is preferable that the width of the thermal fusion bonding part in the exterior body is 5 to 20 mm.

The lithium ion secondary battery of the present invention can be used in a condition of an upper limit voltage at charge of 4.35 V or more, so that a high capacity can be accomplished while superior characteristics can be maintained stably even when it is repeatedly used for a long time of period. Beyond that voltage, it is possible to use it by setting the upper limit voltage at charge at 4.4 V or more. In addition, it is preferable that the upper limit voltage at charge of the lithium ion secondary battery is 4.7 V or less.

### EXAMPLES

Hereinafter, the present invention is described in more detail based on the examples. It is, however, noted that the following examples should not be used to narrowly construe the scope of the present invention.

### Example 1

### <Preparation of the Positive Electrode>

Li₂CO₃ as a Li-containing compound, Co₃O₄ as a Co-containing compound, Mg(OH)₂ as a Mg-containing compound, ZrO₂ as a Zr-containing compound, and Al(OH)₃ as an Al-containing compound were put into a mortar at an appropriate mixture ratio, and mixed and hardened into a pellet form. Using a muffle furnace, it was burned at 950° C. in the atmosphere (in the atmospheric pressure) for 24 hours. Thereby obtained was a lithium cobalt oxide (Al) whose composition formula was found to be LiCo_{0.9795}Mg_{0.011}Zr_{0.0005}Al_{0.009}O₂ by means of the ICP (Inductive Coupled Plasma) method.

Then, into 200 g of a lithium hydroxide aqueous solution at a pH of 10 and at a temperature of 70° C., 10 g of the lithium cobalt oxide (Al) was put. After stirring for dispersion, 0.0154 g of Al(NO₃)₃.9H₂O and an ammonium solution to suppress a pH fluctuation were dropped over a period of 5 hours, to produce an Al(OH)₃ coprecipitation matter, so as to adhere it to the surface of the lithium cobalt oxide (Al). Then, the lithium cobalt oxide (Al) that the Al(OH)₃ coprecipitation matter were attached to was taken out from the reaction liquid. After washing and drying, a heat treatment was carried out at a temperature of 400° C. in the atmosphere for ten hours, thereby obtaining a positive electrode material (a1) in which a coating film of the Al-containing oxide was formed on the surface of the lithium cobalt oxide (Al).

With respect to the positive electrode material (a1) obtained, its average particle diameter was measured by means of the method as described before, thereby finding that it was 27 μm.

Li₂CO₃ as a Li-containing compound, Co₃O₄ as a Co-containing compound, Mg(OH)₂ as a Mg-containing compound, and Al(OH)₃ as an Al-containing compound were put into a mortar at an appropriate mixture ratio, and mixed and hardened into a pellet form. Using a muffle furnace, it was burned at 950° C. in the atmosphere (in the atmospheric pressure) for 4 hours. Thereby obtained was a lithium cobalt oxide (B1) whose composition formula was found to be LiCo_{0.97}Mg_{0.012}Al_{0.009}O₂ by means of the ICP method.

Then, into 200 g of a lithium hydroxide aqueous solution at a pH of 10 and at a temperature of 70° C., 10 g of the lithium cobalt oxide (B1) was put. After stirring for dispersion, 0.077 g of Al(NO₃)₃.9H₂O and an ammonium solution to suppress a pH fluctuation were dropped over a period of 5 hours, to produce an Al(OH)₃ coprecipitation matter, so as to adhere it to the surface of the lithium cobalt oxide (B1). Then, the lithium cobalt oxide (B1) that the Al(OH)₃ coprecipitation matter were attached to was taken out from the reaction liquid. After washing and drying, a heat treatment was carried out at a temperature of 400° C. in the atmosphere for ten hours, thereby obtaining a positive electrode material (b1) in which a coating film of the Al-containing oxide was formed on the surface of the lithium cobalt oxide (B1).

With respect to the positive electrode material (b1) obtained, its average particle diameter was measured by means of the method as described before, thereby finding that it was 7 μm.

Then, the positive electrode material (a1) and the positive electrode material (b1) were mixed at a mass ratio of 85:15 to obtain a positive electrode material (1) for battery preparation. The average coating thickness of the Al-containing oxide formed on the surface of the positive electrode material (1) was measured by means of the method described before, thereby finding that it was 30 nm. In addition, when measuring the average coating thickness, the composition of the coating film was analyzed by an element mapping method, thereby confirming that the main component was Al₂O₃. Furthermore, the positive electrode material (1) was analyzed on the particle size distribution by volume standard. It was found that its average particle diameter was 25 μm, and that there were two peaks, each having the peak top corresponding to the average particle diameter of the positive electrode material (a1) or the positive electrode material (b1). In addition, the BET specific surface area of the positive electrode material (1) was measured by using a specific surface area measurement device by means of a nitrogen adsorption method, thereby finding that it was 0.25 m²/g.

96.5 parts by mass of the positive electrode material (1), 20 parts by mass of an NMP solution containing P(VDF-CTFE) as a binder at a concentration of 10 mass %, and 1.5 parts by mass of acetylene black as a conductive assistant were kneaded with a twin screw extruder, into which an NMP was further added to adjust a viscosity, so as to prepare a positive electrode composition containing paste. This paste was coated on both surfaces of an aluminum foil having a thickness of 15 μm, and then dried at 120° C. for 12 hours in vacuum to obtain a positive electrode composition layer having formed on both surfaces of the aluminum foil. It was then subject to a press work, and cut into a predetermined size to obtain a positive electrode in a belt shape. Here, when the aluminum foil is coated with the positive electrode composition containing paste, the aluminum foil was partly exposed in such a way that a portion on the front surface where it was coated with should have been correspondingly coated on the back surface. The thickness of the positive electrode composition layer of the positive electrode (when the positive electrode composition layer was formed on both surfaces of the aluminum foil, the thickness here was with respect to one surface) was 55μm.

The positive electrode in the belt shape having formed the positive electrode composition layer on both surfaces of the aluminum foil were punched with a Thompson blade, in such a way that the exposed part of the aluminum foil (i.e., the positive electrode current collector) was partly projected to become a tab part, and that the application part of the positive electrode composition layer was shaped into nearly a quadrangle having curved and rounded its four corners. Thereby obtained was a positive electrode for batteries having a positive electrode composition layer formed on both surfaces of the positive electrode current collector. FIG. 1 is a plan view schematically showing the positive electrode for batteries (here, the size of the positive electrode shown in FIG. 1 does not necessarily correspond to the actual size in order to make it easy to understand the structure of the positive electrode). The positive electrode 10 has a shape serving as a tab part 13 formed by being punched in such a way that a part of the exposed part of the positive electrode current collector 12 was projected. The shape of the application part of the positive electrode composition layer 11 has nearly a quadrangle having the four corners rounded. Each length of a, b and c in the drawing was 8 mm, 37 mm and 2 mm, respectively.

### <Preparation of the Negative Electrode>

A complex Si-1 in which the surfaces of SiO were coated with a carbon material (the materials S had an average particle size of 5 μm and a specific surface area of 8.8 m²/g, in which the quantity of the carbon materials in the complex was 10 mass %) was used as a negative electrode active material. 100 parts by mass of a polyacrylic acid were put into 500 parts by mass of ion exchanged water to be stirred and mixed, into which 70 parts by mass of NaOH were added and stirred to be dissolved until a pH value reached 7 or less. Then, additional ion exchanged water was added to adjust the concentration to obtain of a 5 mass % aqueous solution of a sodium salt of the polyacrylic acid. Into this aqueous solution, the negative electrode active material as obtained above, an 1 mass % aqueous solution of CMC, and carbon black were added and stirred for mixing to obtain a negative electrode composition containing paste. Here, the paste above had a composition ratio (a mass ratio) of the negative electrode active material: carbon black: the sodium salt of the polyacrylic acid: CMC was 94:1.5:3:1.5.

The negative electrode composition containing paste was applied on one surface or both surfaces of a copper foil having a thickness of 10 μm, and dried to form a negative electrode composition layer formed on the one surface or the both surfaces of the copper foil. After a press work process was applied to adjust the density of the negative electrode composition layer to be 1.2 g/cm³, followed by cutting it with a predetermined size, to obtain a negative electrode having a belt shape. Here, when the negative electrode composition containing paste is coated on the copper foil, it was done such that the copper foil was partly exposed. When the negative electrode composition layer was formed on the both surfaces, a portion on the front surface where it was coated with should have been correspondingly coated on the back surface.

The negative electrode in the belt shape as explained above was punched with a Thompson blade, in such a way that the exposed part of the copper foil (i.e., the negative electrode current collector) was partly projected to become a tab part, and that the application part of the negative electrode composition layer was shaped into nearly a quadrangle having curved and rounded its four corners. Thereby obtained was a negative electrode for batteries having a negative electrode composition layer formed on both surfaces and one surface of the negative electrode current collector. FIG. 2 is a plan view schematically showing the negative electrode for batteries (here, the size of the negative electrode shown in FIG. 2 does not necessarily correspond to the actual size in order to make it easy to understand the structure of the negative electrode). The negative electrode 20 has a shape serving as a tab part 23 formed by being punched in such a way that a part of the exposed part of the negative electrode current collector 22 was projected. The shape of the formation part of the negative electrode composition layer 21 has nearly a quadrangle having the four corners curved. Each length of d, e and fin the drawing was 9 mm, 38 mm and 2 mm, respectively.

### <Preparation of Separator>

3 parts by mass of a denatured polybutylacrylate as a resin binder, 97 parts by mass of boehmite powders (average particle diameter: 1 μm), and 100 parts by mass of water were mixed to prepare a slurry for forming a porous layer (II). This slurry was applied on one surface of a fine porous membrane made of polyethylene for lithium ion batteries having a thickness of 12 μm [i.e., a porous layer (I)], and dried. As a result, there was prepared a separator in which one surface of the porous layer (I) was provided with the porous layer (II) mainly constituted by boehmite. Here, the thickness of the porous layer (II) was 3 μm.

There were provided two sheets of the negative electrodes for batteries having formed the negative electrode composition layer on one surface of the negative electrode current collector; 16 sheets of the negative electrodes for batteries having formed the negative electrode composition layer on both surfaces of the negative electrode current collector; 17 sheets of the positive electrodes for batteries having formed the positive electrode composition layer on both surfaces of the positive electrode current collector. Furthermore, a stacked electrode body 50 was obtained by alternately disposing the negative electrodes for batteries having formed the negative electrode composition layer on one surface of the negative electrode current collector, the positive electrodes for batteries having formed the positive electrode composition layer on both surfaces of the positive electrode current collector, and the negative electrodes for batteries having formed the negative electrode composition layer on both surfaces of the negative electrode current collector. In addition, each separator 40 was disposed between each positive electrode and each negative electrode in a manner that the porous layer (II) faces the positive electrode. Thereby obtained stacked electrode body 50 was the same as shown in FIG. 3 except for the number of the sheets of the positive electrode, the negative electrode and the separator.

### <Preparation of Third Electrode>

A third electrode 30 having a structure shown in FIG. 4 was prepared as follow. A copper foil having a through hole penetrating from one surface thereof to the other surface thereof (its thickness was 10 μm, the diameter of the through hole was 0.1 mm, and the pore rate was 47%) was cut into a size of 45×25 mm, thereby obtaining a third electrode current collector 32 having a third electrode tab part 31 with a size of 2×2 mm. Furthermore, two sheets of a Li foil 33, each having a thickness of 200 μm and a mass of 20 mg, were provided; and each was pressed and adhered to the portion close to both ends of the third electrode current collector 32, which was then folded into an alphabet character C, thereby obtaining the third electrode 30.

### <Assembling of Battery>

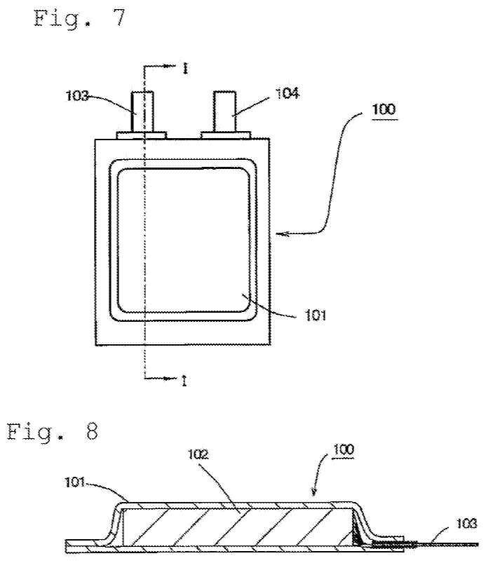

The tab parts from the positive electrodes, the tab parts from the negative electrodes and the tab part from the third electrode as prepared before were respectively welded together. The stacked electrode body 50 and the third electrode 30 were assembled to obtain an electrode body 102 as shown in FIG. 5 except for the structure of the stacked electrode body 50 (i.e., the number of sheets of the electrodes and separators). A aluminum laminate film having a thickness of 0.15 mm, a width of 34 mm, a height of 50 mm and a cavity to house the stacked electrode body 50 was provided. Into the cavity, the stacked electrode body was inserted, and on the top, another aluminum laminate film having the same size was placed. The three sides of the aluminum laminate films were welded together. Then, from the rest of the sides of the aluminum laminate films, a nonaqueous electrolyte liquid (i.e., a solution made by providing a mixture solvent of propylene carbonate, ethylene carbonate and diethyl carbonate at a volume ratio of 20:10:70, into which LiPF₆ was dissolved at a concentration of 1 mol/L, followed by adding 5 mass % of vinylene carbonate, 5 mass % of 4-fluoro-1,3-dioxolane-2-one, 0.5 mass % of adiponitrile, and 0.5 mass % of 1,3-dioxane) was injected. Then, the remaining one side of the aluminum laminated films was sealed by means of a vacuum heat process. Thereby obtained was a lithium ion secondary battery having an appearance shown in FIG. 7, and a cross sectional structure shown in FIG. 8.

Here, FIG. 7 and FIG. 8 are explained. FIG. 7 is a plan view schematically showing a lithium ion secondary battery, and FIG. 8 is a cross section view at line I-I of FIG. 7. The lithium ion secondary battery 100 has a structure below. Inside the aluminum laminate film exterior body 101 composed of two sheets of aluminum laminate films, there are provided the electrode body 102, and the nonaqueous electrolyte liquid (not shown). The aluminum laminate film exterior body 101 has a structure in which the outer periphery thereof is sealed by heat fusion of the aluminum laminate films at the top and the bottom thereof. It is noted that in FIG. 8, illustration of the drawing is simplified, so that it does not show each layer constituting the aluminum laminate film exterior body 101, and the positive electrode, negative electrode and a separator constituting the electrode body is not distinctively illustrated.

The positive electrodes in the electrode body 102 are connected with each other by welding the tab parts to be unified. The unified body of the tab parts welded in this way is connected to the positive electrode external terminal 103 inside battery 100. In addition, while not illustrated in the drawing, the negative electrodes and the third electrode in the electrode body 102 are also connected with each other by welding the tab parts to be unified, and the unified body of the tab parts welded in this way is connected to the negative electrode external terminal 104 inside battery 100. Then, the positive electrode external terminal 103 and the negative electrode external terminal 104 are drawn outside the aluminum laminate film exterior body 101 in order to allow them to connect to external devices. The lithium ion secondary battery as prepared above was kept in a constant temperature bath at 45° C. for 1 hours.

### Example 2

A lithium ion secondary battery was prepared in the same manner as Example 1 except for the followings: A complex Si-2 in which the surfaces of SiO were coated with a carbon material (an average particle size of 5 μm, a specific surface area of 7.9 m²/g, in which the quantity of the carbon materials in the complex was 8 mass %) was used as a negative electrode active material. The mixture solvent to be used as a nonaqueous electrolyte liquid was of propylene carbonate and diethyl carbonate at a volume ratio of 30:70.

### Example 3

30 mass % of graphite A (which is composed of mother particles of natural graphite whose surfaces were coated with an amorphous carbon originated from pitch as a carbon source, and has an average particle size of 10 μm.) and 70 mass % of the complex Si-1 were mixed with a V-type blender for 12 hours to obtain a negative electrode active material. Then, except for using the negative electrode active material above and a Li foil 33 having a mass of 14 mg per one sheet, the same procedure as Example 1 was carried out to prepare a lithium ion secondary battery.

### Example 4

50 mass % of graphite A and 50 mass % of the complex Si-1 were mixed with a V-type blender for 12 hours to obtain a negative electrode active material. Then, except for using the negative electrode active material above and a Li foil 33 having a mass of 10 mg per one sheet, the same procedure as Example 1 was carried out to prepare a lithium ion secondary battery.

### Example 5

70 mass % of graphite A and 30 mass % of the complex Si-1 were mixed with a V-type blender for 12 hours to obtain a negative electrode active material. Then, except for using the negative electrode active material above and a Li foil 33 having a mass of 6 mg per one sheet, the same procedure as Example 1 was carried out to prepare a lithium ion secondary battery.

### Example 6

A lithium ion secondary battery was prepared in the same manner as Example 1 except for that the mixture solvent to be used as a nonaqueous electrolyte liquid was of propylene carbonate, ethylene carbonate and diethyl carbonate at a volume ratio of 10:20:70.

### Example 7

A lithium ion secondary battery was prepared in the same manner as Example 1 except for that the mixture solvent to be used as a nonaqueous electrolyte liquid was of propylene carbonate and diethyl carbonate at a volume ratio of 50:50.

### Example 8

Except for changing the quantity of Al(NO₃)₃.9H₂O into 0.0026 g, the same procedure as producing the positive electrode material (a1) was carried out to prepare a positive electrode material (a2). With respect to the positive electrode material (a2) obtained, its average particle diameter was measured by means of the method as described before, thereby finding that it was 27 μm.

In addition, except for changing the quantity of Al(NO₃)₃.9H₂O into 0.013 g, the same procedure as producing the positive electrode material (b1) was carried out to prepare a positive electrode material (b2). With respect to the positive electrode material (b2) obtained, its average particle diameter was measured by means of the method as described before, thereby finding that it was 7 μm.

Then, the positive electrode material (a2) and the positive electrode material (b2) were mixed at a mass ratio of 85:15 to obtain a positive electrode material (2) for battery preparation. The average coating thickness of the Al-containing oxide formed on the surface of the positive electrode material (2) was measured by means of the method described before, thereby finding that it was 5 nm. In addition, when measuring the average coating thickness, the composition of the coating film was analyzed by an element mapping method, thereby confirming that the main component was Al₂O₃. Furthermore, the positive electrode material (2) was analyzed on the particle size distribution by volume standard. It was found that its average particle diameter was 25 μm, and that there were two peaks, each having the peak top corresponding to the average particle diameter of the positive electrode material (a2) or the positive electrode material (b2). In addition, the BET specific surface area of the positive electrode material (2) was measured by using a specific surface area measurement device by means of a nitrogen adsorption method, thereby finding that it was 0.25 m²/g.

Except for replacing the positive electrode material (1) with the positive electrode material (2), the same procedure as Example 1 was carried out to prepare a positive electrode. Then, except for using this positive electrode, the same procedure as Example 1 was carried out to prepare a lithium ion secondary battery.

### Example 9

Except for changing the quantity of Al(NO₃)₃.9H₂O into 0.0256 g, the same procedure as producing the positive electrode material (a1) was carried out to prepare a positive electrode material (a3). With respect to the positive electrode material (a3) obtained, its average particle diameter was measured by means of the method as described before, thereby finding that it was

In addition, except for changing the quantity of Al(NO₃)₃.9H₂O into 0.128 g, the same procedure as producing the positive electrode material (b1) was carried out to prepare a positive electrode material (b3). With respect to the positive electrode material (b3) obtained, its average particle diameter was measured by means of the method as described before, thereby finding that it was 7 μm.

Then, the positive electrode material (a3) and the positive electrode material (b3) were mixed at a mass ratio of 85:15 to obtain a positive electrode material (3) for battery preparation. The average coating thickness of the Al-containing oxide formed on the surface of the positive electrode material (3) thus obtained was measured by means of the method described before, thereby finding that it was 50 nm. In addition, when measuring the average coating thickness, the composition of the coating film was analyzed by an element mapping method, thereby confirming that the main component was Al₂O₃. Furthermore, the positive electrode material (3) was analyzed on the particle size distribution by volume standard. It was found that its average particle diameter was 25 μm, and that there were two peaks, each having the peak top corresponding to the average particle diameter of the positive electrode material (a3) or the positive electrode material (b3). In addition, the BET specific surface area of the positive electrode material (3) was measured by using a specific surface area measurement device by means of a nitrogen adsorption method, thereby finding that it was 0.25 m²/g.

Except for replacing the positive electrode material (1) with the positive electrode material (3), the same procedure as Example 1 was carried out to prepare a positive electrode. Then, except for using this positive electrode, the same procedure as Example 1 was carried out to prepare a lithium ion secondary battery.

### Example 10

The lithium cobalt oxide (Al) and the lithium cobalt oxide (B1) prepared in in the same manner as Example 1 were mixed at a mass ratio of 85:15 to obtain a positive electrode material (4) for battery preparation.

96.5 parts by mass of the positive electrode material (4), 17 parts by mass of an NMP solution containing P(VDF-CTFE) as a binder at a concentration of 10 mass %, 1.3 parts by mass of acetylene black as a conductive assistant, and 0.5 parts by mass of alumina filler having an average particle diameter of 0.7 μm were kneaded with a twin screw extruder, into which an NMP was further added to adjust a viscosity, so as to prepare a positive electrode composition containing paste. Except for using this positive electrode composition containing paste, the same procedure as Example 1 was carried out to prepare a positive electrode; and except for using this positive electrode, the same procedure as Example 1 was carried out to prepare a lithium ion secondary battery.

### Example 11

96.5 parts by mass of LiCoO₂ as a positive electrode active material, 17 parts by mass of an NMP solution containing P(VDF-CTFE) as a binder at a concentration of 10 mass %, 1.3 parts by mass of acetylene black as a conductive assistant, and 0.5 parts by mass of alumina filler having an average particle diameter of 0.7 μm were kneaded with a twin screw extruder, into which an NMP was further added to adjust a viscosity, so as to prepare a positive electrode composition containing paste. Except for using this positive electrode composition containing paste, the same procedure as Example 1 was carried out to prepare a positive electrode; and except for using this positive electrode, the same procedure as Example 1 was carried out to prepare a lithium ion secondary battery.

### Example 12

Except for using a Li foil 33 having a mass of 17.5 mg per one sheet, the same procedure as Example 1 was carried out to prepare a lithium ion secondary battery.

### Example 13

Except for using a Li foil 33 having a mass of 22.5 mg per one sheet, the same procedure as Example 1 was carried out to prepare a lithium ion secondary battery.

### Example 14

A battery was prepared in the same manner as Example 1, and then, a test was carried out in the same manner as Example 1 except for setting the upper limit voltage at charge at 4.35 V as described later.

### Example 15

A negative electrode in a belt shape was prepared in the same manner as Example 1. The negative electrode composition layer of the belt-shaped negative electrode was doped with Li ions. Then, there were provided a nonaqueous electrolyte (i.e., a solution made by providing a mixture solvent of ethylene carbonate and diethyl carbonate at a volume ratio of 30:70, into which LiPF₆ was dissolved at a concentration of 1 mol/L, followed by adding 4 mass % of vinylene carbonate and 5 mass % of 4-fluoro-1,3-dioxolane-2-one) and a lithium metal pole inside an electrolyte liquid bath. Between the negative electrode and the lithium metal pole in the electrolyte liquid bath, electricity was powered at a condition equivalent to a current density of 0.2 mA/cm² per the area of the negative electrode and a quantity of electricity of 500 mAh/g per the mass of the negative electrode active material, so as to dope the negative electrode composition layer with Li ions.

The negative electrode after doped with Li ions was washed in a washing tank provided with diethyl carbonate, followed by drying it in a drying tank filled tiwh argon gas.

The negative electrode after dried above was punched with a Thompson blade, in such a way that the exposed part of the copper foil (i.e., the negative electrode current collector) was partly projected to become a tab part, and that the application part of the negative electrode composition layer was shaped into nearly a quadrangle having curved and rounded its four corners, so as to obtain a negative electrode for batteries having a negative electrode composition layer doped with Li ions and formed on both surfaces and one surface of the negative electrode current collector. Except for using this negative electrode for batteries having a negative electrode composition layer doped with Li ions, the same procedure as Example 1 was carried out to prepare a stacked electrode body. Then, except for that no third electrode was used and that the one after the assembling was not kept in a constant temperature bath of 45° C. for one week, the same procedure as Example 1 was carried out to prepare a lithium ion secondary battery.

### Comparative Example 1

A lithium ion secondary battery was prepared in the same manner as Example 1 except for that the mixture solvent to be used as a nonaqueous electrolyte liquid was of ethylene carbonate and diethyl carbonate at a volume ratio of 30:70.

### Comparative Example 2

A lithium ion secondary battery was prepared in the same manner as Example 1 except for that the mixture solvent to be used as a nonaqueous electrolyte liquid was of propylene carbonate, ethylene carbonate and diethyl carbonate at a volume ratio of 5:25:70.

### Comparative Example 3

A lithium ion secondary battery was prepared in the same manner as Example 1 except for that the mixture solvent to be used as a nonaqueous electrolyte liquid was of propylene carbonate and diethyl carbonate at a volume ratio of 60:40.

Various properties as explained below were evaluated on the lithium ion secondary batteries of the Examples and the Comparative Examples.

### <Measurement of the Li Quantity in the Positive Electrode Active Material>

Five lithium ion secondary batteries from each of the Examples and the Comparative Examples were applied to a constant current charge at a current value of 0.5 C to reach 4.4 V (4.35 V for Example 14), followed by applying a constant voltage of 4.4 V (4.35 V for Example 14) to reach a current value of 0.02 C. Then, they were discharged at a discharge current rate of 0.1 C to reach a voltage of 2.0 V. Then, the aluminum laminate film exterior body was dismantled in a glove box to take out the positive electrode only. Thereby collected positive electrode was washed with diethyl carbonate, and then, the positive electrode composition layer was taken out. By means of the ICP method as mentioned above, the metal composition ratio of Li and metals other than Li, Li/M (Li: the quantity of Li; and M: the quantity of the metals other than Li) was calculated to obtain an averaged value of the five. These evaluation results are shown in Table 2.

### <Initial Characteristic Evaluation>

Five lithium ion secondary batteries from each of the Examples and the Comparative Examples (these batteries were separately provided from those used for the Li/M calculation as explained before) were applied to a constant current charge at a current value of 0.5 C to reach 4.4 V (4.35 V for Example 14), followed by applying a constant voltage of 4.4 V (4.35 V for Example 14) to reach a current value of 0.02 C. Then, the battery was discharged at a constant current of 0.2 C to reach 2.0 V, to obtain an initial discharge capacity. The results of the average of five batteries are shown in Table 2. It is noted that the initial discharge capacity is a relative value when that of Comparative Example 1 is assumed as 100.

### <60° C. Storage Characteristic Evaluation>

The lithium ion secondary batteries after the initial characteristic evaluation (i.e., five from each examples) were applied to a constant current charge at a current value of 0.5 C to reach 4.4 V (4.35 V for Example 14), followed by applying a constant voltage of 4.4 V (4.35 V for Example 14) to reach a current value of 0.02 C. After the charge, the thickness of the battery (i.e., the thickness in the direction from the top to the bottom shown in FIG. 7) with a thickness gauge to obtain a pre-storage thickness. Each battery after measuring the pre-storage thickness was kept in a constant temperature bath for 7 days while the temperature was adjusted at 60° C., and then taken out from the constant temperature bath to cool it at room temperature for 3 hours, followed by measuring the thickness with a thickness gauge, thereby obtaining a post-storage thickness. A rate of the thickness change before and after the storage was obtained by the following equation. The results of the average of the five are shown in Table 2.

Rate of thickness change (%)=(post-storage thickness−pre-storage thickness)/pre-storage thickness×100

### <Charge Discharge Cycle Characteristic Evaluation>

The lithium ion secondary batteries after the initial characteristic evaluation (i.e., five from each examples) were applied to a constant current charge at a current value of 0.5 C to reach 4.4 V (4.35 V for Example 14), followed by applying a constant voltage of 4.4 V (4.35 V for Example 14) to reach a current value of 0.02 C. Then, the battery was discharged at a constant current of 0.2 C to reach 2.0 V, to obtain an initial discharge capacity. Then, each battery was charged at a constant current at a current value of 1 C to reach 4.4 V, and then it was charged at a constant voltage of 4.4 V to reach a current value of 0.05 C, followed by discharging it at a current value of 1 C to reach a voltage of 2.0 V. These sequences are assumed to be one cycle, and this cycle was repeated 300 times. Then, each battery was subject to a constant-current constant-voltage charge and a constant-current discharge at the same conditions as having measured the initial discharge capacity, so as to obtain a discharge capacity. Then, the value obtained as the discharge capacity was divided by the value obtained as the initial discharge capacity, such that the result was expressed as a percentage, thereby obtaining a cycle capacity maintenance rate. An average of the five was calculated. These evaluation results are shown in Table 2. In addition, the lithium ion secondary battery of the Example 1 (these batteries were separately provided from the evaluation previously explained), which circuit voltage had been measured, was charged at a constant current and at a constant voltage to reach 4.2 V. This battery was referred to Reference Example 1, and its initial characteristic evaluation, its 60° C. storage characteristic evaluation and its charge discharge cycle characteristic evaluation were carried out. These results are shown in Table 2.

TABLE 1

| | Negative | | | | |
|---|---|---|---|---|---|
| | electrode | Positive | | | |
| | Content of | electrode | | | |
| | material S in | Average | | | |
| | the negative | thickness | | | |
| | electrode | of the | Solvents of the electrolyte | | |
| | active | Al-containing | liquid | | |
| | material | coating film | PC | EC | DEC |
| | (mass %) | (nm) | (vol %) | (vol %) | (vol %) |
| Example 1 | 100 | 30 | 20 | 10 | 70 |
| Example 2 | 100 | 30 | 30 | 0 | 70 |
| Example 3 | 70 | 30 | 20 | 10 | 70 |
| Example 4 | 50 | 30 | 20 | 10 | 70 |
| Example 5 | 30 | 30 | 20 | 10 | 70 |
| Example 6 | 100 | 30 | 10 | 20 | 70 |
| Example 7 | 100 | 30 | 50 | 0 | 50 |
| Example 8 | 100 | 5 | 20 | 10 | 70 |
| Example 9 | 100 | 50 | 20 | 10 | 70 |
| Example 10 | 100 | — | 20 | 10 | 70 |
| Example 11 | 100 | — | 20 | 10 | 70 |
| Example 12 | 100 | 30 | 20 | 10 | 70 |
| Example 13 | 100 | 30 | 20 | 10 | 70 |
| Example 14 | 100 | 30 | 20 | 10 | 70 |
| Example 15 | 100 | 30 | 20 | 10 | 70 |
| Comp. Ex. 1 | 100 | 30 | 0 | 30 | 70 |
| Comp. Ex. 2 | 100 | 30 | 5 | 25 | 70 |
| Comp. Ex. 3 | 100 | 30 | 60 | 0 | 40 |
| Ref. Ex. 1 | 100 | 30 | 20 | 10 | 70 |

TABLE 2

| | | | A rate of the | |
|---|---|---|---|---|
| | | | thickness | Cycle |
| | | | change after | capacity |
| | | Initial discharge | storage at 60° C. | maintenance |
| | Li/M | capacity | (%) | rate (%) |
| Example 1 | 0.9 | 100 | 3 | 80 |
| Example 2 | 0.9 | 100 | 3 | 77 |
| Example 3 | 0.9 | 95 | 2 | 83 |
| Example 4 | 0.9 | 90 | 2 | 85 |
| Example 5 | 0.9 | 85 | 1 | 90 |
| Example 6 | 0.9 | 100 | 7 | 88 |
| Example 7 | 0.9 | 100 | 2 | 75 |
| Example 8 | 0.9 | 100 | 6 | 78 |
| Example 9 | 0.9 | 100 | 3 | 75 |
| Example 10 | 0.9 | 100 | 5 | 74 |
| Example 11 | 0.9 | 100 | 6 | 74 |
| Example 12 | 0.8 | 95 | 3 | 80 |
| Example 13 | 1.05 | 100 | 4 | 80 |
| Example 14 | 0.9 | 97 | 3 | 82 |
| Example 15 | 0.9 | 100 | 2 | 80 |
| Comp. Ex. 1 | 0.9 | 100 | 14 | 80 |
| Comp. Ex. 2 | 0.9 | 100 | 13 | 80 |
| Comp. Ex. 3 | 0.9 | 90 | 3 | 60 |
| Ref. Ex. 1 | 0.9 | 89 | 1 | 80 |

There are other embodiments than the description above without departing the gist of the present invention. The embodiment described above is an example, and the present invention is not limited to the embodiment. The scope of the present invention should be construed primarily based on the claims, not to the description of the specification or the present application. Any changes within the ranges of the claims and the equivalence thereof should be construed as falling within the scope of the claims.

### Industrial Utility

The lithium ion secondary battery of the present invention can be used as the same applications as those of conventionally known lithium ion secondary batteries.

### EXPLANATION OF THE REFERENCES IN THE DRAWINGS

10: Positive electrode;
11: Positive electrode composition layer;
12: Positive electrode current collector;
13: Tab part;
20: Negative electrode;
21: Negative electrode composition layer;
22: Negative electrode current collector;
23: Tab part;
30: Third electrode;
31: Third electrode tab part;
32: Third electrode current collector;
33: Li foil;
40: Separator
50: Stacked electrode body;
100: Lithium ion secondary battery;
101: Metal laminated film exterior body;
102: electrode body;
103: Positive electrode external terminal; and
104: Negative electrode external terminal.

1. A lithium ion secondary battery, comprising: an electrode body comprising a positive electrode, a negative electrode and a separator therebetween which are stacked or wound; and a nonaqueous electrolyte liquid,
wherein the negative electrode has a negative electrode composition layer mainly composed of a negative electrode active material provided on at least one surface of a negative electrode current collector, the negative electrode active material including a materials S including Si,
wherein assuming that a total of all negative electrode active materials included in the negative electrode is 100 mass %, a content of the material S is 5 mass % or more,
wherein the nonaqueous electrolyte liquid comprises propylene carbonate and a chain carbonate as a solvent,
wherein a volume content of the propylene carbonate in the solvent is 10 to 50 volumes %,
wherein the positive electrode comprises a positive electrode composition layer comprising a metal oxide comprising Li and a metal M except for Li as a positive electrode active material provided on at least one surface of a positive electrode current collector, and
wherein the lithium ion secondary battery has an upper limit voltage in charge is 4.35 V of more.

2. The lithium ion secondary battery according to claim 1,
wherein the positive electrode comprises a positive electrode material in which a surface of particles of the positive electrode active material is coated with an Al-containing oxide,
wherein the Al-containing oxide has an average coating thickness of 5 to 50 nm,
wherein the positive electrode active material contained in the positive electrode material comprises a lithium cobalt oxide comprising Co and at least one kind of an element M¹ selected from the group consisting of Mg, Zr, Ni, Mn, Ti and Al.

3. The lithium ion secondary battery according to claim 1, wherein the material S is a negative electrode material comprising SiOx including Si and O as constituent elements (wherein an atom ratio x of the O with respect to the Si is 0.5≤x≤1.5).

4. The lithium ion secondary battery according to claim 1, wherein at the time when the lithium ion secondary battery is discharged at an discharge current rate of 0.1 C to reach a voltage of 2.0 V, a molar ratio (Li/M) of the Li and the metal M except for the Li contained in the positive electrode active material is 0.8 to 1.05.

5. The lithium ion secondary battery according to claim 1, wherein the separator comprises a porous membrane (I) mainly composed of a thermoplastic resin, and a porous layer (II) mainly composed of fillers having a heat resistant temperature of 150° C. or more.

6. The lithium ion secondary battery according to claim 1, wherein the the lithium ion secondary battery further comprises a third electrode to insert Li ions into the negative electrode,
wherein the third electrode is disposed at least at an end face of the electrode body stacked such that the third electrode is electrically conductive with the negative electrode.

7. The lithium ion secondary battery according to claim 1, wherein the negative electrode has been made of the negative electrode composition layer including the negative electrode active material not including Li, the negative electrode composition layer being doped with Li ions.

8. A method for producing the lithium ion secondary battery according to claim 6, comprising:
using the third electrode having a Li supply source; and
electrically connecting the third electrode with the negative electrode to insert Li ions into the negative electrode.

9. A method for producing the lithium ion secondary battery according to claim 7, comprising:
providing the negative electrode having the negative electrode composition layer comprising a material not including Li and a binder;
doping the negative electrode composition layer with Li ions; and
then using the negative electrode to manufacture the lithium ion secondary battery.

10. The lithium ion secondary battery according to claim 2, wherein at the time when the lithium ion secondary battery is discharged at an discharge current rate of 0.1 C to reach a voltage of 2.0 V, a molar ratio (Li/M) of the Li and the metal M except for the Li contained in the positive electrode active material is 0.8 to 1.05.
